(19) United States
(12) Patent Application Publication
(10) Pub. No.: US 2026/0064480 A1
(43) Pub. Date: Mar. 5, 2026

(54) HYBRID ALLOCATION SCHEME FOR LOAD-BALANCED DATA GROUPS IN DISTRIBUTED NODES

(71) Applicant: Palantir Technologies Inc., Denver, CO (US)

(72) Inventors: Priyanshu Kumar, London (GB); Jeremy Kong, London (GB)

(73) Assignee: Palantir Technologies Inc., Denver, CO (US)

(21) Appl. No.: 19/368,618

(22) Filed: Oct. 24, 2025

Related U.S. Application Data
(60) Provisional application No. 63/889,705, filed on Sep. 29, 2025.

(51) Int. Cl. G06F 9/50

(52) U.S. Cl. CPC G06F 9/5044

(57) ABSTRACT

Various examples, systems, and methods are disclosed relating to a hybrid allocation scheme for load-balanced data groups in distributed nodes. Some systems can allocate, using an allocation scheme corresponding to a first phase, a plurality of data groups to a plurality of nodes. Some systems can update, using a correction scheme corresponding to a second phase, at least one allocation of at least one data group of the plurality of data groups based at least on a convergence parameter and a resource metric. The resource metric corresponds to at least one resource indicator of a hardware configuration detected from at least one node of the plurality of nodes based at least on performance of at least one node command.

### CROSS-REFERENCE TO RELATED APPLICATIONS

The present application claims the benefit of U.S. Provisional Patent Application No. 63/889,705, filed on Sep. 29, 2025, the entire disclosure of which is incorporated by reference herein.

### BACKGROUND

Implementing allocation of data to data storages in distributed computing environments involves processing resource-dependent constraints, such as heterogeneous hardware configurations, dynamic workload patterns, and server capacity limits. Some traditional systems apply an allocation scheme that deterministically assigns data groups to servers without reference to various indicators, resulting in persistent load imbalances and inefficient resource utilization. Additionally, updating allocations based on metrics can require a large number of data migrations during topology changes, increasing operational complexity and reducing system responsiveness. As a result, existing systems fail to efficiently allocate data in a resource-aware manner, reduce migration overhead, and maintain adaptability.

### SUMMARY

Implementations of the present disclosure relate to systems and methods for allocating data groups to nodes using a two-phase approach including an allocation scheme and a correction scheme. Systems and methods are disclosed that generate a plurality of data groups from a plurality of data objects, assign the data groups to a plurality of servers using a first allocation scheme based on a mapping function, and update at least one allocation of at least one data group using a second-phase correction scheme based at least on a convergence parameter and a resource metric. For example, systems and methods in accordance with the present disclosure can determine resource indicators such as memory usage, processor usage, or network usage for each node by accessing operating system or hardware interfaces and performing node commands, and apply a function to prioritize resource indicators according to a hardware configuration of at least one (e.g., each) node. The two-phase approach facilitates migration of data groups as discrete units, improves load balancing based on current resource conditions, and provides bounded convergence for real-time (or near real-time) adaptation to server topology changes. The disclosed systems and methods can be applied in distributed databases, cloud storage platforms, and/or scalable data processing frameworks to improve resource utilization and operational efficiency.

In some aspects, the techniques described herein relate to a method, including: allocating, using an allocation scheme corresponding to a first phase, a plurality of data groups to a plurality of nodes; and updating, using a correction scheme corresponding to a second phase, at least one allocation of at least one data group of the plurality of data groups based at least on a convergence parameter and a resource metric, the resource metric corresponding to at least one resource indicator of a hardware configuration detected from at least one node of the plurality of nodes based at least on performance of at least one node command; wherein the method is performed using one or more processors.

In some aspects, the techniques described herein relate to a method, wherein to update the at least one allocation of the at least one data group includes: determining a resource indicator for each of the plurality of nodes based at least on the hardware configuration corresponding to at least one of a memory usage, a processor usage, a network usage, an application value, a thread value, or an API call value for each node of the plurality of nodes.

In some aspects, the techniques described herein relate to a method, wherein to update the at least one allocation of the at least one data group includes: identifying the at least one node of the plurality of nodes based at least on the resource metric of the at least one node indicating a relative level of capacity compared to at least one other node of the plurality of nodes.

In some aspects, the techniques described herein relate to a method, wherein the relative level of capacity includes a measure of utilization, availability, or load corresponding to the at least one resource indicator.

In some aspects, the techniques described herein relate to a method, wherein the at least one data group is reallocated from an overloaded node of the plurality of nodes to a compatible node of the plurality of nodes, the compatible node identified based at least on a second resource metric of the compatible node, the second resource metric indicating a higher available resource capacity for the at least one data group compared to the plurality of nodes.

In some aspects, the techniques described herein relate to a method, wherein to update the at least one allocation of the at least one data group of the plurality of data groups includes: updating, using the correction scheme corresponding to the second phase for a plurality of iterations, a plurality of allocations of the plurality of data groups among the plurality of nodes until the convergence parameter is satisfied.

In some aspects, the techniques described herein relate to a method, wherein the convergence parameter corresponds to at least one of (i) an iteration limit corresponding to reallocation, (ii) an iteration parameter corresponding to a decrease in a sum of a plurality of resource metrics exceeding a resource parameter, (iii) at least one termination condition.

In some aspects, the techniques described herein relate to a method, further including: determining the resource metric of the at least one node based at least on applying a first scoring function to a plurality of first resource indicators of the at least one node; and determining a second resource metric of at least one second node based at least on applying a second scoring function to a plurality of second resource indicators of the at least one second node; wherein the first scoring function includes a first weight prioritization of the plurality of first resource indicators based at least one first hardware configuration of the at least one node, and wherein the second scoring function includes a second weight prioritization of the plurality of second resource indicators based at least one second hardware configuration of the at least one second node.

In some aspects, the techniques described herein relate to a method, further including: detect, by accessing an operating system (OS) or hardware interface of the at least one node and performing the at least one node command, the at least one first hardware configuration based at least on telemetry data of the at least one node returned from the performance of the at least one node command.

In some aspects, the techniques described herein relate to a method, wherein each of the plurality of nodes operate independently from other nodes of the plurality of nodes, and wherein a plurality of first data groups allocated to a first node of the plurality of nodes is disjoint from a plurality of second data groups allocated to a second node of the plurality of nodes.

In some aspects, the techniques described herein relate to a method, wherein to allocate the plurality of data groups to the plurality of nodes includes: assigning a plurality of data objects into the plurality of data groups, wherein the plurality of data groups satisfies a size parameter.

In some aspects, the techniques described herein relate to a method, wherein to allocate the plurality of data groups to the plurality of nodes includes: aggregating a plurality of weights of the plurality of data objects of at least one of the plurality of data groups to generate a plurality of aggregated weights, each aggregated weight corresponding to a corresponding data group of the plurality of data groups; and generating an ordered structure including a plurality of virtual nodes, at least one virtual node corresponding to at least one of the plurality of nodes, the ordered structure used to allocate the plurality of data groups to the plurality of nodes based at least on the plurality of aggregated weights.

In some aspects, the techniques described herein relate to a method, wherein the correction scheme corresponds to a plurality of reallocation operations to reallocate at least one of the plurality of data groups among the plurality of nodes based at least on a plurality of resource metrics.

In some aspects, the techniques described herein relate to a method, wherein the allocation scheme corresponds to a plurality of allocation operations to (i) generate the plurality of data groups using a plurality of data objects and (ii) allocate the plurality of data groups based at least on at least one mapping function.

In some aspects, the techniques described herein relate to a system, including: at least one processor to execute operations including: apply an allocation scheme to a plurality of data groups to cause an allocation of the plurality of data groups to a plurality of nodes; and apply a correction scheme to the plurality of nodes to cause an update in at least one allocation of at least one data group of the plurality of data groups based at least on a convergence parameter and a resource metric, the resource metric corresponding to at least one resource indicator of a hardware configuration of at least one node of the plurality of nodes.

In some aspects, the techniques described herein relate to a system, wherein the operations, when executed by the at least one processor, further cause the at least one processor to: determine a resource indicator for each of the plurality of nodes based at least on the hardware configuration corresponding to at least one of a memory usage, a processor usage, a network usage, an application value, a thread value, or an API call value for each node of the plurality of nodes.

In some aspects, the techniques described herein relate to a system, wherein the operations, when executed by the at least one processor, further cause the at least one processor to: identify the at least one node of the plurality of nodes based at least on the resource metric of the at least one node indicating a relative level of capacity compared to at least one other node of the plurality of nodes.

In some aspects, the techniques described herein relate to a system, wherein the relative level of capacity includes a measure of utilization, availability, or load corresponding to the at least one resource indicator.

In some aspects, the techniques described herein relate to a system, wherein the at least one data group is reallocated from an overloaded node of the plurality of nodes to a compatible node of the plurality of nodes, the compatible node identified based at least on a second resource metric of the compatible node, the second resource metric indicating a higher available resource capacity for the at least one data group compared to the plurality of nodes.

In some aspects, the techniques described herein relate to a non-transitory computer-readable medium storing instructions that, when executed by at least one processor, cause the at least one processor to perform operations including: allocate, using an allocation scheme corresponding to a first phase, a plurality of data groups to a plurality of nodes; and update, using a correction scheme corresponding to a second phase, at least one allocation of at least one data group of the plurality of data groups based at least on a convergence parameter and a resource metric, the resource metric corresponding to at least one resource indicator of a hardware configuration of at least one node of the plurality of nodes.

### BRIEF DESCRIPTION OF THE DRAWINGS

The present systems and methods for load-balanced data groups in distributed nodes are described in detail below with reference to the attached drawing figures, wherein:

FIG. 1 is an example block diagram of a system, in accordance with some implementations of the present disclosure;

FIG. 2 is a flow diagram showing a method for load-balanced data groups in distributed nodes, in accordance with some implementations of the present disclosure;

FIG. 3 is an example system for allocating and correcting data group allocations among nodes, in accordance with some implementations of the present disclosure;

FIG. 4 is an example system depicting resource metrics and resource usage values for a plurality of nodes, in accordance with some implementations of the present disclosure;

FIG. 5 is an example system for grouping data objects into data groups using an allocation system 104, in accordance with some implementations of the present disclosure;

FIG. 6A is a readiness ranking table for multiple allocation and correction pipelines, in accordance with some implementations of the present disclosure;

FIG. 6B is a performance scatter plot comparing load balancing quality and execution time for multiple allocation and correction pipelines, in accordance with some implementations of the present disclosure; and

FIG. 6C is an execution time versus quality matrix for multiple allocation and correction pipelines, in accordance with some implementations of the present disclosure.

### DETAILED DESCRIPTION

This disclosure relates to systems and methods for allocating data groups to nodes in distributed computing environments using a two-phase allocation and correction model. Some systems configured to distribute data across nodes in distributed computing environments can exhibit imbalanced resource utilization, increased migration overhead, and/or limited adaptability to changes in node topology. For example, some systems implement allocation schemes that deterministically assign data to nodes without reference to resource indicators, resulting in persistent load imbalances when nodes have heterogeneous hardware configurations and/or workloads. Other systems implement allocation updates based on metrics, but such approaches can require a large number of data migrations during scaling events or node failures, which increases operational complexity and reduces responsiveness. Additionally, some systems lack bounded convergence guarantees, resulting in unpredictable or prolonged allocation updates. As a result, existing approaches do not provide both resource-aware allocation and migration efficiency for data in dynamic distributed environments, and do not adapt to evolving workload patterns and/or hardware changes among nodes.

In some implementations, the system can generate a plurality of data groups from a plurality of data objects and assign the data groups to a plurality of nodes using an allocation scheme corresponding to a first phase (or stage). The allocation scheme can apply a mapping function to assign data groups to nodes, which can result in persistent load imbalances when nodes have heterogeneous hardware configurations and/or workloads. For example, the system can assign the plurality of data groups to the plurality of nodes based on a deterministic mapping function (e.g., consistent hashing) applied at the data group level, which can produce an allocation in which the number of data groups assigned to each node is approximately balanced but does not inherently account for heterogeneity in the aggregate resource requirements of the data groups or in the hardware configurations of the nodes. That is, deterministic mapping can result in load imbalances when one or more data groups have aggregate resource requirements that are significantly greater than those of other data groups, such as aggregate memory usage, aggregate processor usage, aggregate network usage, or any combination thereof, and when such data groups cannot be decomposed into smaller groups for distribution. In some examples, the entire data group must be serviced by a single node, regardless of the available capacity of the node, which can lead to disproportionate utilization of the resources of that node. In some implementations, consistent hashing can be augmented with techniques such as the use of multiple virtual nodes per physical node to improve statistical distribution and to partially address heterogeneity among nodes. However, these techniques do not resolve the imbalance caused by the presence of non-decomposable data groups with disproportionately high resource demands. Furthermore, deterministic mapping functions such as consistent hashing do not guarantee that data groups with the highest aggregate resource requirements will be allocated to different nodes, and can therefore result in scenarios in which a small subset of data groups is responsible for a majority of the total system load while being concentrated on a limited number of nodes. The correction scheme corresponding to the second phase can address these limitations by evaluating the resource metrics of at least one (e.g., each) node, identifying nodes whose assigned data groups cause capacity constraint violations, and reallocating data groups with high aggregate resource requirements to compatible nodes with higher available capacity. In some implementations, the correction scheme can iteratively perform such reallocations until a convergence parameter is satisfied, thereby mitigating and/or reducing load imbalances that deterministic mapping functions cannot avoid and improving resource utilization across heterogeneous and dynamic node configurations.

In some implementations, the system can update at least one allocation of at least one data group using a correction scheme corresponding to a second phase (or stage). The correction scheme can determine resource indicators for at least one (e.g., each) node by accessing an operating system and/or hardware interface and performing at least one node command to obtain telemetry data, such as memory usage, processor usage, and/or network usage. The system can apply a scoring function to the resource indicators, where the scoring function can include a weight prioritization based on the hardware configuration of at least one (e.g., each) node. The correction scheme can iteratively reallocate data groups among nodes based on a convergence parameter and/or the computed resource metrics, such that at least one (e.g., each) allocation update can be performed until the convergence parameter is satisfied. That is, in some implementations, the correction scheme can further evaluate one or more intrinsic properties of the data groups in addition to the resource metrics when determining reallocation operations, such as the number of constituent files, records, and/or other discrete data objects associated with at least one (e.g., each) data group, the aggregate size of those constituent elements, and/or the distribution of access frequencies across them. In some examples, the number of files corresponding to a data group can be used as an additional weighting factor and/o selection criterion, such that data groups with a high file count and/or high aggregate file size can be prioritized for reallocation to nodes with greater available capacity or lower current load.

This two-phase approach can reduce the number of data group migrations required during topology changes and can improve load balancing by accounting for resource conditions of the nodes. That is, in some implementations, the correction scheme can also account for heterogeneity in the aggregate resource requirements of the data groups themselves, including scenarios in which one or more data groups include data objects that must and/or should be processed together on the same node due to application-level constraints, data locality requirements, and/or processing dependencies, and/or therefore cannot be subdivided or split across multiple nodes. Additionally, in some examples, the presence of such non-decomposable data groups with disproportionately high aggregate resource demands can be mitigated and/or reduced by reallocating them to nodes with greater available capacity or lower current utilization. The systems and methods described herein can be applied in distributed databases, cloud storage platforms, and/or data processing frameworks, among other examples.

Systems and methods in accordance with the present disclosure allocate data groups to nodes using a two-phase process that separates initial allocation from resource-aware correction. For example, implementations can generate a plurality of data groups (e.g., buckets, partitions, segments, and/or any logical grouping) from a plurality of data objects (e.g., shards, records, files, and/or any data unit) and assign the data groups to a plurality of nodes (e.g., servers, computing devices, virtual machines (VM), and/or any data storage) using an allocation scheme corresponding to a first phase, such as a deterministic mapping function. Telemetry data can be collected from at least one (e.g., each) node by accessing an operating system (OS) or hardware interface and performing at least one node command to obtain resource indicators, including memory usage, processor usage, and/or network usage. Additionally, a correction scheme corresponding to a second phase can be applied, where a scoring function can prioritize resource indicators based on the hardware configuration of at least one (e.g., each) node to compute a resource metric. The correction scheme can iteratively update allocations of data groups among the nodes based on the resource metrics and a convergence parameter, such as an iteration limit or a reduction in resource metric violations. Thus, the systems and methods provide technical improvements over traditional allocation approaches by reducing the number of data group migrations required during topology changes and/or improving allocation convergence, thereby providing resource-aware load balancing, and/or allowing real-time (or near real-time) adaptation to heterogeneous and dynamic node environments.

Systems and methods in accordance with the present disclosure can generate a plurality of data groups from a plurality of data objects, and at least one (e.g., each) data group can be assigned to at least one node (e.g., computing device, virtual machine, physical node, and/or any data storage) using an allocation scheme. At least one data group of the plurality of data groups can correspond with at least one resource indicator (e.g., memory usage, processor usage, network usage, and/or any hardware or software metric) of a node (e.g., computing device, virtual machine, physical node, and/or any data storage). That is, the disclosed systems and methods can transform a set of data objects into grouped allocations across nodes, where at least one (e.g., each) data group is associated with aggregated resource requirements. The resource indicators can be used in a correction scheme corresponding to a second phase, where a scoring function can prioritize resource indicators based on the hardware configuration of at least one (e.g., each) node to compute a resource metric. Thus, the allocation encoding provides a two-phase process that separates initial, resource-agnostic assignment from resource-aware correction. Accordingly, the systems and methods can provide technical improvements to data distribution in distributed environments. By maintaining a mapping of data group assignments to nodes together with associated node resource indicators, implementations address technical inefficiencies (e.g., excessive migration operations during topology changes, persistent load imbalances due to static allocation, inability to efficiently adapt to heterogeneous node configurations, and/or increased processing time for real-time (or near real-time) rebalancing) of traditional methods and support allocation and correction for distributed databases, cloud storage systems, and/or scalable data processing platforms.

Additionally, systems and methods in accordance with the present disclosure can update allocations of data groups (e.g., buckets, partitions, segments, and/or any logical grouping) among nodes (e.g., computing devices, virtual machines, physical nodes, and/or any data storage) using a correction scheme corresponding to a second phase based at least on resource metrics and convergence parameters. For example, implementations can determine resource indicators (e.g., memory usage, processor usage, network usage, and/or any hardware or software metric) for at least one (e.g., each) node by accessing an operating system or hardware interface and performing at least one node command, and/or can compute a resource metric for at least one (e.g., each) node using a scoring function that prioritizes resource indicators according to the hardware configuration of the node. The correction scheme can iteratively reallocate data groups among the nodes based on the resource metrics, where at least one (e.g., each) iteration can reduce the number of resource metric violations and/or improve load balancing.

The systems and methods can provide technical improvements by reducing the number of data group migration operations required during topology changes from O(S/N) (e.g., big O notation) individual data object moves in traditional approaches to O(B/N) data group moves, where S is the number of data objects, B is the number of data groups, and N is the number of nodes. That is, in some implementations, the correction scheme can be configured and/or implemented to accept as an input a migration budget parameter corresponding to a maximum number of data group reallocations to be performed during the second phase, such that the reallocation process can be bounded according to operational constraints and/or user-defined limits while still improving load distribution. For example, the migration budget parameter can be used to control the trade-off between the total number of data group moves and the quality of the resulting load balancing output, allowing a user or system policy to prioritize either minimal migration overhead or maximal resource utilization balance depending on the requirements of the deployment environment.

In some implementations, the systems and methods can reduce the computational complexity of allocation updates from O(S*N) individual data object reallocation operations, where at least one (e.g., each) data object is evaluated for assignment to at least one (e.g., each) node, to O(B*N) data group reallocation operations. In Phase 1, the total time complexity for bucket creation and allocation can be O(S+V log V+B log V) (e.g., compared to O(S*N) for direct per-object, per-node assignment, which is up to hundreds or thousands of times more processing for large S and N), where V is the number of virtual nodes, and S>>V>>B in practice, resulting in near-linear scaling with the number of data objects. In Phase 2, the greedy correction process has a worst-case complexity of O(B²*N) (e.g., compared to O(S²*N) for iterative per-object rebalancing, which is orders of magnitude greater storage and processing overhead for large S), but often operates in O(B*N) time due to early convergence within a small number of iterations. By migrating data groups as units and leveraging a two-phase approach, the systems and methods decrease the total number of migration operations, reduce computational overhead, and/or maintain balanced resource utilization across nodes. Accordingly, the systems and methods can improve scalability, reduce operational complexity, and/or facilitate updates in distributed environments with heterogeneous and dynamic node configurations.

The systems and methods described herein can be applied to distributed data management and processing in environments with heterogeneous and dynamic node configurations, including use cases such as cloud storage platforms, distributed databases, scalable data processing frameworks, content delivery networks, and/or real-time (or near real-time) analytics clusters. The architecture provides technical improvement to resource-aware data distribution by separating initial allocation from capacity-driven correction, thereby reducing migration overhead and computational complexity. The system can dynamically adapt allocations in response to topology changes, workload shifts, and/or hardware upgrades, supporting real-time (or near real-time) rebalancing without requiring global knowledge of all node states. The implementations reduce reliance on per-object migration and static allocation, instead providing scalable, resource-aware, and convergence-bounded data group assignment to improve operational efficiency, adaptability, and/or resource utilization across distributed computing environments.

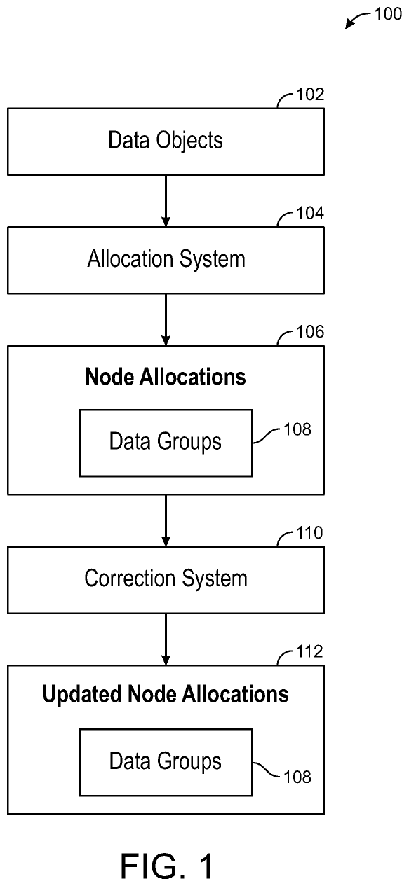

With reference to FIG. 1, FIG. 1 shows an example block diagram of a system 100, in accordance with some implementations of the present disclosure. This and other arrangements described herein are provided as examples. Other arrangements and elements (e.g., machines, interfaces, functions, orders, and/or groupings of functions) can be used in addition to or instead of those shown, and/or some elements can be omitted. Many of the elements described are functional entities that can be implemented as discrete components, distributed components, and/or combined in any suitable configuration. Functions described as being performed by entities and/or systems can be carried out by hardware, firmware, and/or software, such as one or more processing circuits executing instructions stored in one or more memory circuits. In some implementations, the system and methods described herein can be implemented using one or more processing circuits, one or more memory circuits, a set of nodes operating in a distributed environment, and/or a data center, computing cluster, or other distributed computing infrastructure.

System 100 can include, among other elements, at least one processing circuit configured to execute instructions, at least one memory circuit configured to store data and instructions, one or more input and/or output interfaces, one or more network interfaces for communication with other systems and/or devices, one or more data storage devices, and/or one or more communication buses operably connecting these components. The processing circuit can include one or more central processing units (CPU), microcontrollers, digital signal processors, and/or other suitable processors. The memory circuit can include volatile memory, non-volatile memory, and/or any combination thereof. The network interface can include wired and/or wireless interfaces. Components of system 100 can be implemented in a single device or distributed across multiple devices, and/or can communicate using a network that can include a local area network (LAN), a wide area network (WAN), the Internet, a cellular network, and/or any combination thereof. The components can communicate over such a network using any suitable communication protocols.

The system 100 can implement at least a portion of an allocation pipeline, such as a bucket creation and assignment pipeline, a consistent hashing pipeline, and/or a correction pipeline. The system 100 can be used to allocate data groups and/or reallocate data groups among nodes based on real-time resource measurements by any of various systems described herein, including but not limited to distributed database systems, cloud storage platforms, scalable data processing frameworks, content delivery networks, analytics clusters, cluster management systems, and/or distributed resource balancing services.

Generally, the allocation pipeline can include operations performed by system 100. For example, the allocation pipeline can include any one or more of a group stage, an allocation stage, and/or a correction stage. At least one (e.g., each) stage of the allocation pipeline can include one or more components of system 100 configured to perform the functions described herein. In some implementations, one or more stages can be performed during topology changes affecting nodes such as scaling events, maintenance operations, and/or node failures. Additionally, one or more stages can be performed during dynamic workload fluctuations, changes in node resource availability, and/or periodic load-balancing cycles.

The system 100 (e.g., implementing the allocation pipeline) can allocate, using an allocation scheme corresponding to a first phase, a plurality of data groups to a plurality of nodes. In some implementations, the system 100 implementing the allocation pipeline can update, using a correction scheme corresponding to a second phase, at least one allocation of at least one data group of the plurality of data groups based at least on a convergence parameter and a resource metric. The resource metric can correspond to at least one resource indicator of a hardware configuration detected from at least one node of the plurality of nodes based at least on performance of at least one node command.

In some implementations, the group stage can be the stage in the allocation pipeline in which the system 100 can generate at least one (e.g., each) data group from a plurality of data objects 102. The system 100 can include at least one allocation system 104. The allocation system 104 can assign a plurality of data objects 102 into the plurality of data groups 108. The plurality of data groups 108 can satisfy a size parameter (e.g., a maximum number of data objects per group, a maximum aggregate resource requirement per group, a target group size, and/or any threshold based on workload characteristic). That is, the allocation system 104 can hash (e.g., consistent, rendezvous), partition (e.g., round-robin, range-based), and/or cluster the data objects 102 by data attribute (e.g., type, category, and/or tag), key (e.g., object identifier, primary key, and/or hash value), or workload characteristic (e.g., access frequency, size, and/or resource demand). For example, during the group stage the allocation system 104 can aggregate at least one (e.g., each) data object into a data group such that the aggregate resource requirements of at least one (e.g., each) data group do not exceed a specified threshold. In some implementations, the allocation system 104 can assign and/or otherwise distribute at least one (e.g., each) data object to a data group by evaluating at least one (e.g., each) data attribute or workload characteristic. The data objects 102 can be shards, records, files, and/or any data unit. That is, the data objects 102 can represent at least one (e.g., each) discrete unit of data to be allocated to a node. For example, the allocation system 104 can generate one thousand data groups 108 from a dataset of two million data objects, with at least one (e.g., each) data group containing approximately two thousand data objects. In this example, the grouping process can be performed such that the aggregate resource requirements of at least one (e.g., each) data group, including total memory usage, total processor usage, and/or total network usage, remain within a specified threshold (e.g., not exceeding 4 gigabytes of memory usage, not exceeding 2500 processor milliseconds per second of sustained workload, not exceeding 150 megabits per second of sustained network throughput) to support balanced allocation across heterogeneous nodes.

Additionally, the data objects 102 can include heterogeneous resource requirements (e.g., memory, threads, CPU) such that the allocation system 104 can generate at least one (e.g., each) data group to account for varying resource consumption. The allocation system 104 can receive data objects D={d1, d2, . . . d3} corresponding to a dataset, workload, or input stream. That is, D can be a collection of data objects 102 where at least one (e.g., each) data object is associated with a resource indicator. For example, the allocation system 104 can generate at least one (e.g., each) data group such that the aggregate resource requirements of at least one (e.g., each) data group do not exceed a specified threshold, thereby supporting balanced allocation across heterogeneous nodes.

In another example, the allocation system 104 can receive a dataset including 100,000 data objects, where at least one (e.g., each) data object 102 corresponds to a unique record in a catalog. The allocation system 104 can assign the 100,000 data objects into a plurality of data groups 108, such that at least one (e.g., each) data group satisfies a size parameter. The allocation system 104 can hash (e.g., consistent, rendezvous), partition (e.g., round-robin, range-based), and/or cluster the data objects 102 by data attribute (e.g., type, category, and/or tag), key (e.g., object identifier, primary key, and/or hash value), and/or workload characteristic (e.g., access frequency, size, and/or resource demand).

During the group stage, the allocation system 104 can aggregate at least one (e.g., each) data object into a data group based on resource requirements, such that in a system with four nodes, at least one (e.g., each) node is assigned approximately one-fourth of the data objects 102. The allocation system 104 can assign and/or otherwise distribute at least one (e.g., each) data object to a data group by evaluating at least one (e.g., each) resource indicator. The data objects 102 can be shards, records, files, and/or any data unit. That is, the data objects 102 can represent at least one (e.g., each) discrete unit of data to be allocated to a node. The allocation system 104 can assign at least one (e.g., each) data object to a data group such that the aggregate resource requirements of at least one (e.g., each) data group do not exceed a specified threshold. In this example, at least one (e.g., each) data group can include a subset of the data objects 102, such that the data objects 102 are partitioned among the plurality of data groups 108 according to the size parameter. When a new node is added, the allocation system 104 can regroup the data objects 102 into a new plurality of data groups 108, such that at least one (e.g., each) data group contains a reduced portion of the data objects 102 (e.g., one-fifth of the data objects 102 in a five-node system). This grouping approach can support scaling to larger datasets and catalog sizes, and can accommodate the data objects 102 with heterogeneous resource requirements.

In some implementations, the allocation stage can be the stage in the allocation pipeline in which the system 100 can assign at least one (e.g., each) data group 108 to at least one (e.g., each) node. The allocation system 104 can allocate, using an allocation scheme (e.g., bucket creation and mapping to nodes, such as consistent hashing) corresponding to a first phase, a plurality of data groups 108 (e.g., buckets including hash shards) to a plurality of nodes (e.g., the node allocations 106). For example, the allocation system 104 can apply an allocation scheme to a plurality of data groups 108 to cause an allocation of the plurality of data groups 108 to a plurality of nodes. That is, the allocation system 104 can use a distribution mechanism (e.g., allocation scheme), such as consistent hashing applied at the data group level, rendezvous hashing applied at the data group level, and/or range-based partitioning applied at the data group level. For example, during allocation stage the allocation system 104 can map at least one (e.g., each) data group to a node based on a deterministic mapping function. In some implementations, the allocation system 104 can allocate and/or otherwise distribute at least one (e.g., each) data group to a node by applying the mapping function to the data group identifier (e.g., bucket ID, partition number, segment label, and/or any unique group label).

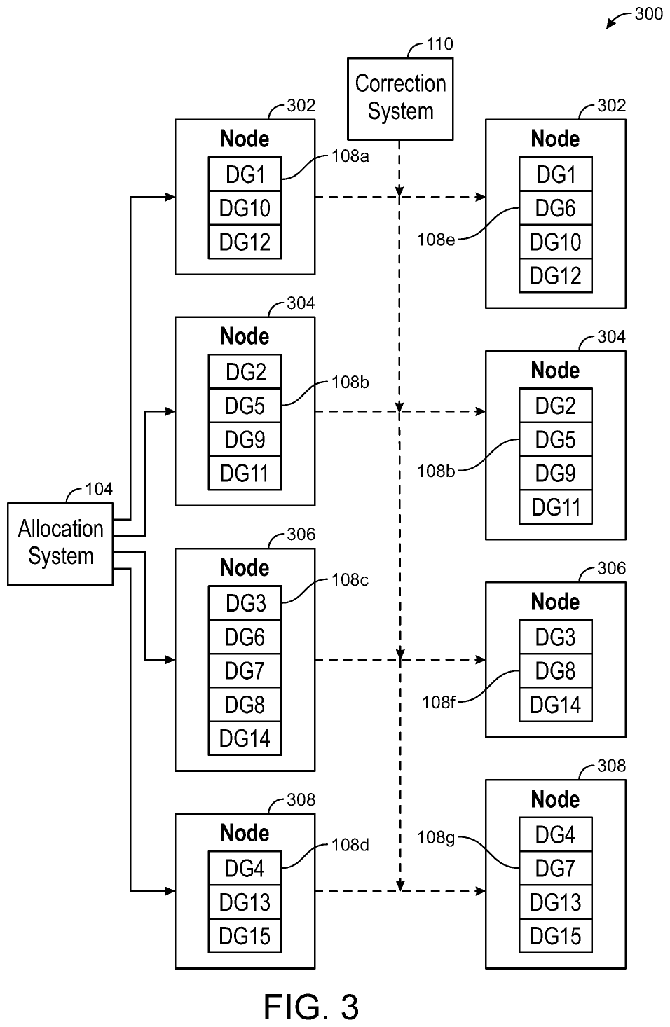

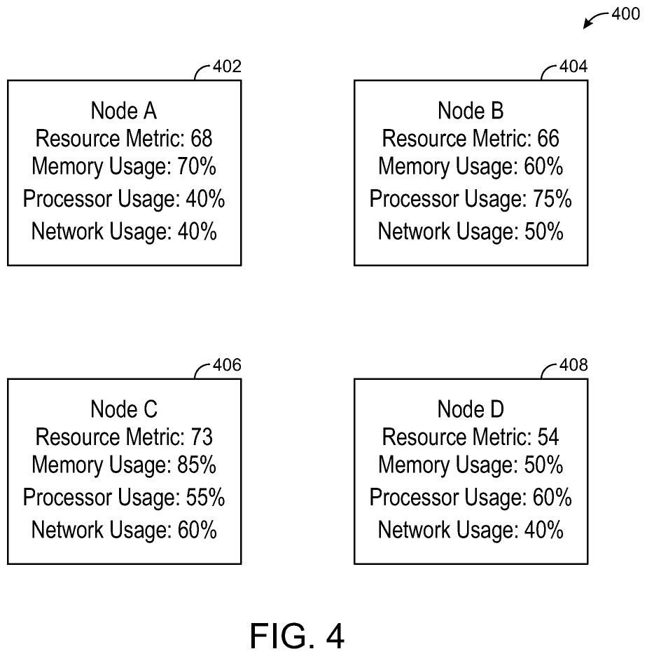

Generally, the node allocations 106 can be a mapping of the data groups 108 to nodes (e.g., the nodes 302-308 of FIG. 3 and/or nodes 402-408 of FIG. 4). The node allocations 106 can represent the assignment of at least one (e.g., each) data group to at least one (e.g., each) node in the system 100. That is, the allocation system 104 can determine which node is responsible for storing or processing at least one (e.g., each) data group. For example, the node allocations 106 can specify that data group B₁ is assigned to node N₁, data group B₂ is assigned to node N₂, and so on. In this example, at least one (e.g., each) node of the node allocations 106 can represent a physical or virtual resource that manages a subset of the data groups 108. That is, the node can store, process, and/or otherwise manage the data objects 102 assigned to its allocated data groups 108.

In some implementations, the node allocations 106 can represent a logical mapping of data groups 108 to nodes that is determined during the allocation stage. The node allocations 106 can serve as an initial assignment, where the data groups 108 are not yet physically stored or processed on the assigned nodes, but instead define a logical distribution that can be subsequently updated. The correction system 110 can then evaluate resource metrics and determine the updated node allocations 112, which can represent a revised mapping based on resource indicators and convergence parameters. In some implementations, the node allocations 106 can be used to assign and store data groups 108 on the corresponding nodes, with the correction system 110 later updating the assignments to achieve balanced resource utilization. Thus, it should be understood that deferred or immediate allocation can be used based on application requirements, system configuration, or operational policy.

The data groups 108 can be buckets, partitions, segments, and/or any logical grouping. That is, the data groups 108 can represent collections of the data objects 102 grouped according to a size parameter and/or resource requirement. For example, the allocation system 104 can generate data groups 108 such that at least one (e.g., each) group contains a specified number of the data objects 102 and/or meets a resource threshold. The nodes can be servers, computing devices, virtual machines (VM), and/or any data storage. That is, the nodes can represent physical or virtual resources capable of storing or processing the allocated data groups. For example, the allocation system 104 can assign at least one (e.g., each) data group to a node for subsequent processing, storage, and/or correction.

In some implementations the allocation scheme can correspond to a plurality of allocation operations to generate the plurality of data groups 108 using a plurality of data objects 102 and allocate the plurality of data groups 108 based at least on at least one mapping function (e.g., consistent hashing with binary search). That is, the allocation system 104 can apply the allocation scheme to a plurality of data groups 108 to deterministically assign at least one (e.g., each) data group to a node (e.g., to create the node allocations 106). For example, the allocation scheme can be a scheme that can be used by the allocation system 104 to perform bucket creation and consistent hashing, deterministic mapping, and/or other distribution approaches. The mapping function can be a hash function, range function, or key-based function. For example, the allocation system 104 can perform consistent hashing by computing a hash value for at least one (e.g., each) data group to assign the data group to a node based on the hash ring. In another example, the allocation system 104 can perform deterministic mapping by applying a range-based function to assign the data groups 108 to nodes based on data group identifiers. In yet another example, the allocation system 104 can perform round-robin assignment (e.g., another distribution approach) by sequentially assigning the data groups 108 to nodes to balance the distribution.

In some implementations, the allocation scheme can be another scheme, such as rendezvous hashing where the data groups 108 can be assigned to nodes based on the highest hash value between data group and node identifiers, and/or weighted allocation where the data groups 108 can be assigned to nodes based on node capacity or resource weighting. It should be understood that while specific mapping functions and allocation schemes are described, any deterministic or probabilistic distribution approach can be used to assign the data groups 108 to nodes within the scope of the present disclosure.

Generally, during the group stage and the allocation stage, the allocation system 104 can generate a stable abstraction layer by assigning at least one (e.g., each) data object to at least one (e.g., each) data group (e.g., bucket, partition, segment, and/or any logical grouping) according to a deterministic mapping function (e.g., hash function, range function, or key-based function). The mapping from the data objects 102 to the data groups 108 can remain fixed, providing a stable intermediate layer between the data objects 102 and the nodes. The allocation system 104 can then assign at least one (e.g., each) data group to at least one (e.g., each) node using a distribution mechanism (e.g., consistent hashing, rendezvous hashing, or range-based assignment) applied at the data group level. This two-stage process provides migration granularity control by migrating entire data groups rather than individual data objects, supports a configurable abstraction by allowing the number of data groups to be tuned (e.g., 256), and/or maintains a stable mapping from the data objects 102 to the data groups 108 even as nodes are added or removed. As illustrated in FIG. 1, the allocation system 104 can apply a mapping function to determine a data group identifier for at least one (e.g., each) data object and then use a distribution mechanism to assign at least one (e.g., each) data group to a node, thereby supporting scalable, migration-efficient, and resource-aware allocation in distributed environments.

For example, during the group stage and the allocation stage, the allocation system 104 can implement a two-phase mapping process that provides a stable bucket abstraction layer between the data objects 102 and nodes. In the group stage, the allocation system 104 can assign at least one (e.g., each) data object S₁, S₂, . . . , Sₙ (e.g., shard, record, or file) to a data group B₁, B₂, . . . , Bₘ (e.g., bucket, partition, or segment) by determining and/or otherwise computing a bucket identifier (bucket_{id}) for at least one (e.g., each) data object using a hash function (e.g., bucket_{id}=hash(f“shard_{shard.id}”) & 0x7FFFFFFF % bucket_{count} (where f“_” can be a formatted string literal, such as a Python f-string) and/or any cryptographic hash function, non-cryptographic hash function, or custom mapping function). The deterministic bucket assignment can output a fixed mapping from the data objects 102 to the data groups 108 (e.g., that does not change as nodes are added or removed, from the node allocations 106). In the allocation stage, the allocation system 104 can assign at least one (e.g., each) data group 108 to a node N₁, N₂, . . . , Nₖ (e.g., computing device, virtual machine, or data storage) by computing a bucket hash (e.g., bucketₕₐₛₕ=hash(f“bucket_{bucket.id}”) & 0x7FFFFFFF and/or any hash function, checksum, or fingerprint) for at least one (e.g., each) data group 108 and performing a consistent hash lookup (e.g., assigned_{node}=consistnentₕₐₛₕ_{ₗₒₒₖᵤₚ} (bucketₕₐₛₕ, virtual_{ring})) to map the bucket to a node using a consistent hashing algorithm (e.g., ring-based consistent hashing, rendezvous hashing, jump consistent hashing) and/or a virtual node ring (e.g., where at least one (e.g., each) node can be represented by multiple virtual nodes on the ring to improve distribution granularity and balance). The group stage and the allocation stage, following the flow from:
S₁, S₂, . . . , Sₙ→[Hash Function]→B₁, B₂, . . . , Bₘ→[Consistent Hashing]→N₁, N₂, . . . , Nₖ

The flow provides migration granularity control by migrating entire buckets (e.g., the data groups 108) rather than individual shards (e.g., the data objects 102), maintains a stable bucket abstraction layer (e.g., intermediate layer) where the shard-to-bucket mapping is maintained, and allows the number of buckets to be configured to tune migration behavior. The implementation of the allocation scheme for bucket-to-node assignment allows improved redistribution of the data groups 108 as nodes are added and/or removed.

In another example, during the allocation stage, the allocation system 104 can implement a virtual node ring to improve distribution granularity and balance among nodes. In some implementations, for at least one (e.g., each) node N₁, N₂, . . . , Nₖ, the allocation system 104 can generate a plurality of virtual nodes by iterating over a range of virtual node identifiers for at least one (e.g., each) physical node (e.g., 40 virtual nodes per physical node). For at least one (e.g., each) virtual node, the allocation system 104 can determine a virtual key (e.g., virtual_{key}=f“node_{node_id}_virtual_{virtual_id”) and determine and/or otherwise compute a virtual hash (e.g., virtual_hash=hash(virtual_{key}) & 0x7FFFFFFF). The allocation system 104 can insert the virtual hash into a ring data structure, associating the virtual hash with the corresponding node identifier (e.g., ring[virtualₕₐₛₕ]=node_{id}). During bucket-to-node assignment, the allocation system 104 can perform a binary search (e.g., O(log V) complexity, where V can be the total number of virtual nodes) on the sorted ring keys to locate the appropriate virtual node for a given bucket hash:

$$index = bisect \cdot {bisect}_{left} ( {sorted}_{{ring}_{keys}} , {bucket}_{hash} )$$

where bisect can be a binary search algorithm or library function (e.g., Python's bisect module), sorted_{ring}_{_{keys}} can be a list of all virtualₕₐₛₕ values in ascending order, and bucketₕₐₛₕ can be a hash value computed for a data group. If the search index exceeds the length of the ring, the allocation system 104 can wrap around to the beginning of the ring (e.g., index=0). The assigned node for a data group (e.g., assigned_node=ring[stored_{ring}_{_{keys}}, bucketₕₐₛₕ[index]]) can be determined by the virtual node ring structure.

In some implementations, the allocation system 104 can generate the node allocations 106 by aggregating shard weights within at least one (e.g., each) bucket. That is, the allocation system 104 can aggregate a plurality of weights (e.g., resource requirements, such as memory usage, processor usage, or network usage) of the plurality of data objects 102 of at least one of the plurality of data groups 108 to generate a plurality of aggregated weights (e.g., total memory weight, total CPU weight, total network weight). For example, the allocation system 104 can sum the memory usage of all the data objects 102 in a data group 108 to produce an aggregated memory weight for that group. At least one aggregated weight can correspond to a corresponding data group of the plurality of data groups 108. For example, the total resource requirement of a data group can be used in subsequent allocation or correction stages to inform node assignment decisions.

Additionally, the allocation system 104 can build an ordered structure of nodes (e.g., virtual node ring with V virtual nodes per physical node). That is, the allocation system 104 can generate an ordered structure (e.g., a ring data structure, such as a consistent hashing ring) including a plurality of virtual nodes. For example, the allocation system 104 can assign 40 virtual nodes to at least one (e.g., each) physical node and insert at least one (e.g., each) virtual node into the ring based on a hash of its virtual key. At least one virtual node can correspond to at least one of the plurality of nodes (e.g., a physical node represented by multiple virtual nodes on the ring). The ordered structure can be used to allocate the plurality of data groups 108 to the plurality of nodes (e.g., to create the node allocations 106) based at least on the plurality of aggregated weights. That is, the allocation system 104 can perform a hash lookup using the aggregated weight and bucket hash to determine the assigned node for at least one (e.g., each) data group. For example, the allocation system 104 can use the ring to map at least one (e.g., each) data group to a node by locating the nearest virtual node in the ordered structure.

In some implementations, the correction stage can be the stage in the allocation pipeline in which the system 100 can identify, adjust, and/or reconcile discrepancies in resource assignments (e.g., to create the updated node allocations 112). The system 100 can include at least one correction system 110. The correction system 110 can update, using a correction scheme corresponding to a second phase, at least one allocation of at least one data group of the plurality of data groups 108 based at least on a convergence parameter and a resource metric. For example, apply a correction scheme to the plurality of nodes to cause an update in at least one allocation of at least one data group of the plurality of data groups 108 based at least on a convergence parameter and a resource metric. The correction scheme can correspond to a plurality of reallocation operations to reallocate at least one of the plurality of data groups 108 among the plurality of nodes based at least on a plurality of resource metrics. That is, the capacity-aware greedy correction operations can be performed by the correction system 110 (e.g., priority-based bucket selection, bottleneck resource detection, and resource-metric-based reallocation). For example, in some implementations, the correction operations can account for broader contextual parameters, such as a predefined migration budget specifying a maximum number of data group moves permitted during the correction stage, by evaluating potential reallocation sequences in aggregate rather than selecting the locally optimal move in each iteration. In such examples, the correction system 110 can generate and assess multiple candidate move sets whose total number of moves does not exceed the migration budget, simulate the resulting resource metric changes for each candidate set, and/or select the sequence that yields the greatest overall reduction in capacity constraint violations and/or the highest improvement in load balancing quality within the permitted move count.

In some implementations, the correction system 110 can perform a post-allocation correction using a greedy capacity-aware correction function, model, and/or algorithm. It should be understood that while a greedy capacity-aware correction function is described in the present implementation, any suitable correction function, including non-greedy approaches such as lookahead-based heuristics, aggregate move set evaluation, and/or global optimization models, can be used to perform the reallocation operations within the scope of the present disclosure. For example, during the correction stage the correction system 110 can adjust the initial allocation (e.g., the node allocations 106) to account for resource constraints and/or convergence or termination constraints. In some implementations, the correction system 110 can update and/or otherwise reallocate at least one data group by evaluating resource indicators (e.g., memory usage, processor usage, network usage) and selecting data groups 108 for migration based on severity scores or overload conditions. That is, the correction system 110 can iteratively and/or repeatedly move buckets (e.g., the data groups 108) from overloaded nodes to compatible and/or non-overloaded nodes, guided by convergence guarantees (e.g., monotonic progress, no cycles, bounded iterations).

Generally, the correction system 110 (e.g., implementing the correction scheme) can calculate node loads from data group assignments, identify nodes exceeding capacity constraints, and apply an iterative greedy correction process with convergence guarantees. For example, the correction system 110 can select the most overloaded node based on a resource metric, move the heaviest bucket from that node to the least-loaded compatible node, and repeat this process until capacity compliance is achieved, no valid moves remain, or a maximum number of iterations is reached. The correction system 110 can enforce convergence safeguards, such as limiting the number of iterations (e.g., to the number of buckets) and ensuring monotonic progress, where at least one (e.g., each) move reduces overall capacity violations.

The correction system 110 can, in some implementations, incorporate a migration budget parameter into the updating operations performed during the correction stage, wherein the migration budget parameter defines a maximum number of data group reallocation operations permitted within a single execution of the second-phase correction scheme. The migration budget parameter can be specified by a user, administrator, or automated policy engine prior to initiation of the correction stage, and can be stored in configuration data accessible to the correction system 110. The correction system 110 can apply the migration budget parameter as part of the convergence parameter set, such that the iterative greedy correction loop terminates when the number of executed data group moves reaches the defined budget, even if additional capacity constraint violations remain. In some implementations, the migration budget parameter can be dynamically adjusted based on operational priorities, such as minimizing migration overhead during peak workload periods or maximizing load balancing quality during maintenance windows. The correction system 110 can track the cumulative number of data group moves performed during the update process, compare this count to the migration budget parameter in at least one (e.g., each) iteration, and/or enforce termination when the budget is exhausted. The migration budget parameter can be used in conjunction with resource metric evaluation, bottleneck resource detection, and/or priority-based bucket selection, allowing the correction system 110 to select moves that provide the greatest reduction in capacity violations per migration operation. By integrating the migration budget parameter into the updating aspect of the correction stage, the system 100 can provide a configurable trade-off between migration cost and/or load balancing quality, providing deployment-specific optimization in heterogeneous and/or dynamic node environments.

The convergence parameter can be convergence safeguards and/or termination conditions, such as all nodes are within capacity, no valid moves remain, maximum iteration count met, and/or any other criteria ensuring correction scheme termination. That is, the convergence parameter can correspond to at least one of (i) an iteration limit corresponding to reallocation, (ii) an iteration parameter corresponding to a decrease in a sum of a plurality of resource metrics exceeding a resource parameter, and/or (iii) at least one termination condition. For example, the correction system 110 can implement a three-layer termination guarantee during the correction stage. The correction system 110 can terminate upon success if no overloaded nodes remain, indicating all capacity constraints are satisfied. The correction system 110 can terminate if no valid bucket moves are available (e.g., preventing infeasible or impossible moves). The correction system 110 can enforce an upper bound on the number of iterations, such as a maximum iteration count equal to the number of buckets, to guarantee termination under any input conditions and prevent infinite loops. Additionally, the correction system 110 can ensure monotonic progress, such that at least one (e.g., each) move improves source node capacity utilization, and/or can apply deterministic selection and consistent tie-breaking to prevent cycling or oscillation. That is, at least one (e.g., each) iteration can either improve allocation or trigger termination, thereby ensuring that cycling or oscillation in the correction process is impossible. In an idealized implementation, a correction algorithm can move at least one (e.g., each) data group at most once, which would result in an upper bound of O(B) iterations where B can be the number of data groups. In some implementations, a data group can be moved more than once if intermediate reallocations are required to satisfy capacity constraints and/or to achieve improved load balancing quality. In such examples, the total number of iterations can exceed B, but the convergence safeguards described herein, including monotonic progress and termination conditions, ensure that the process completes in a finite number of steps while avoiding repeated cyclic moves between nodes

In some implementations, the correction system 110 can implement a correction scheme using a correction scheme loop (also referred to herein as a “greedy correction loop”) with convergence parameters. For example, the correction system 110 can set a maximum iteration count, such as maxᵢₜₑᵣₐₜᵢₒₙₛ=len(datagroups), which can be an upper bound (e.g., 20 iterations, 100 iterations, 256 iterations). For at least one (e.g., each) iteration within the range of maxᵢₜₑᵣₐₜᵢₒₙₛ, the correction system 110 can identify capacity violations by computing overloaded_{nodes}=find_overloaded_nodes(node_{loads}, capacityₗᵢₘᵢₜₛ). If no overloaded nodes are found, the correction system 110 can terminate the process, indicating that all capacity constraints are satisfied. If overloaded nodes are present, the correction system 110 can determine the bucket move for the most overloaded node by evaluating bestₘₒᵥₑ=find_best_move(most_{overloaded}_{_{node}}, capacity_{constraints}). If bestₘₒᵥₑ is None, meaning no moves are available, the correction system 110 can terminate the process, indicating that no valid moves remain. If a valid move is identified, the correction system 110 can execute the bucket move using execute_bucket_move(bestₘₒᵥₑ) and increment a move counter (e.g., moves_{made}+=1). The correction scheme loop can continue until one of the termination conditions is met: all nodes are within capacity, no valid moves remain, and/or the maximum number of iterations is reached, thereby guaranteeing termination and preventing infinite loops under any input conditions.

Implementations of the correction scheme can include re-allocating and/or otherwise distributing the data groups 108 to updated node allocations 112 produced by the correction system 110. For example, the correction system 110 can update the assignment of at least one (e.g., each) data group 108 to a node as specified in the updated node allocations 112, based on the results of the greedy correction loop. The correction system 110 can update the allocation state by changing the mapping of the data groups 108 from overloaded nodes to less-loaded compatible nodes, as determined by resource metrics (e.g., memory usage, processor load, network utilization) and/or convergence parameters. In some implementations, the correction system 110 can generate the updated node allocations 112 that reflect the current assignment of the data groups 108 to nodes, incorporating changes made during at least one (e.g., each) iteration of the correction scheme loop. The correction system 110 can use these updated node allocations 112 to provide subsequent actions, such as distributing requests, managing access, and/or scheduling operations for the data groups 108 according to the new allocation.

For example, execute_bucket_move can include updating the mapping of a selected data group 108 from a source node to a destination node in the updated node allocations 112. In this example, execute_bucket_move can include removing the data group 108 from the list of assigned data groups for an overloaded node, and adding the data group 108 to the list of assigned data groups for a least-loaded compatible node, as determined by the correction system 110. This can further include updating metadata or allocation tables to reflect the new assignment, recalculating node loads to account for the change, and recording the move in a log or audit record. In some implementations, execute_bucket_move can also trigger ancillary actions, such as notifying other system components of the updated allocation, updating resource usage statistics, and/or preparing the system 100 for subsequent allocation or correction steps.

The node_{loads} can be represented as a resource metric determined from at least one resource indicator of a node. The resource metric can be a severity score corresponding to any computed score, ratio, and/or quantitative value that reflects, for a node or assignment, the extent of capacity constraint violation. The resource metric can correspond to at least one resource indicator of a hardware configuration detected from at least one node of the plurality of nodes based at least on performance of at least one node command. In some implementations, the correction system 110 can determine (e.g., during the correction stage) a resource indicator (e.g., quantification of the resource state of at least one (e.g., each) node) for each of the plurality of nodes based at least on the hardware configuration corresponding to at least one of a memory usage, a processor usage, a network usage, an application value, a thread value, or an API call value for at least one (e.g., each) node (e.g., per-node) of the plurality of nodes.

The memory usage and/or memory coefficient of variation (CV) can be the amount or percentage of RAM currently and/or simulated (e.g., when logical allocations are performed for planning or simulation purposes) consumed by the storage-related workload (caches, metadata, buffers) of the node and/or by data groups 108 assigned to that node. While the usages and values described herein are referenced as real and/or simulated values, it should be understood simulated and/or estimated usages or values can be determined when node allocation is logical and/or performed as part of a planning process such that the system 100 can evaluate potential allocation outcomes before actual data movement. That is, the memory usage can indicate how much headroom remains for additional data groups. For example, higher memory usage can indicate tighter memory headroom and a higher potential need to move at least one data group away from that node. The processor usage and/or CPU can be the CPU resources consumed by the storage-related tasks of nodes, expressed as a percentage of total CPU capacity (or per-core usage aggregated across cores). That is, the processor usage can indicate how busy the node is computing for I/O scheduling, encryption/compression, metadata processing. For example, higher usage can indicate reduced capacity to take on more work.

The network usage can be a volume of storage-related network activity on the node, including bandwidth usage, throughput, and/or observed latency for storage traffic. That is, the network usage can indicate whether the node can handle additional data transfers (e.g., replication, reads/writes to remote stores) without becoming a bottleneck. For example, higher network usage can indicate lower capacity for extra data movement. The application value can be a per-application measure of storage workload impact on the node, such as per-app IOPS, cache pressure, and/or per-app contribution to storage latency. That is, the application value can indicate how some applications can stress storage differently. For example, increases or decreases in a severity score of a node can be based on app-specific storage behavior.

The thread value can be an availability or utilization of storage-related threads (concurrency units, IO worker threads) on the node. That is, the thread value can indicate how many parallel storage operations the node can handle. For example, lower thread availability can raise the relative severity score of the node. The API call value can be a rate or count of storage-related API calls (e.g., reads/writes, object-store operations) issued to or from the node (e.g., with per-API latency). That is, high API call load can throttle storage performance. For example, high API call load can increase the severity score of the node when API throughput approaches limits.

Generally, the correction system 110 can detect at least one first hardware configuration based at least on telemetry data of the at least one node returned from the performance of the at least one node command. That is, the correction system 110 can access an operating system (OS) or hardware interface (e.g., via SSH, remote API, SNMP, IPMI, system call, or agent software running locally) of the at least one node and perform the at least one node command (e.g., reading/proc/meminfo, running vmstat, querying SNMP, query system counters via PowerShell, or Windows API, and/or any other low-level system command or read from a system file or API). In some implementations, accessing the OS and/or hardware interface can include establishing a secure connection, authenticating with system credentials, and/or invoking a monitoring agent. For example, the correction system 110 can retrieve memory and CPU usage statistics by executing a shell command or querying a system API. In another example, the correction system 110 can collect network usage data by polling SNMP counters and/or reading from a network interface file. A node command can include reading a system file, executing a shell command, invoking a remote API, polling a hardware sensor, and/or any telemetry retrieval operation. In some implementations, performance of the node command can include parsing the output, extracting relevant metrics, and storing the values for further analysis. For example, the correction system 110 can parse the output of a node command to extract memory and CPU usage values. In another example, the correction system 110 can aggregate telemetry data from multiple nodes to build a system-wide resource profile. The telemetry data can be measured, reported, and/or collected information from a node (e.g., computing system) about the state of its hardware and software resources.

The hardware configuration can be scored and/or otherwise quantified by applying a scoring function to a plurality of resource indicators corresponding to the hardware resources of at least one (e.g., each) node (e.g., memory capacity, processor capacity, network bandwidth, thread availability, and/or API call capacity). The quantification of the hardware configuration can be the resource indicator. That is, the correction system 110 can use returned node command to determine current values for memory usage, processor usage, and network usage for at least one (e.g., each) node. For example, the correction system 110 can retrieve memory usage and CPU utilization statistics from the operating system or hardware interface of a node and use these values as resource indicators. In this example, the correction system 110 can compute a severity score for the node by applying a weighted sum to the resource indicators, where the weights can be determined based on the hardware configuration of the node (e.g., assigning higher weight to memory usage for memory-constrained nodes). In another example, the correction system 110 can compare the computed severity score to a capacity threshold to determine whether the node is overloaded. In this example, the correction system 110 can use the quantified hardware configuration to guide the reallocation of data groups, prioritizing moves that relieve the most constrained hardware resource on the most overloaded node.

In some implementations, the correction system 110 can use the resource indicators to determine the resource metrics. That is, the correction system 110 can compute a resource metric for each node by applying a scoring function to the resource indicators. In some implementations, at the correction stage, the correction system 110 can determine the resource metric (node_{load}_{₁}) of at least one node based at least on applying a first scoring function to a plurality of first resource indicators of the at least one node. That is, the correction system 110 can apply a node-specific scoring function that weights memory, CPU, and/or network usage according to the hardware configuration of the node. For example, the correction system 110 can assign a higher weight to memory usage for memory-constrained nodes (e.g., nodes with lower installed RAM, determined by querying system memory capacity or configuration files) and a higher weight to CPU usage for compute-intensive nodes (e.g., nodes with higher processor core counts or higher CPU utilization, determined by querying CPU specifications or monitoring CPU usage statistics). In this example, the correction system 110 can dynamically adjust the scoring function based on the hardware configuration or workload profile of each node. The first scoring function can include a first weight prioritization (e.g., weighted sum, composite function, custom groups or tuning) of the plurality of first resource indicators based at least one first hardware configuration of the at least one node. That is, the correction system 110 can assign weights to memory, CPU, and network usage based on the hardware profile of the node to compute a severity score for correction decisions.

In some implementations, the correction system 110 can determine the resource metric (node_{load}_{₂}) of at least one second node based at least on applying a second scoring function to a plurality of second resource indicators of the at least one second node. That is, the correction system 110 can apply a different set of weights or a different scoring function customized to the hardware configuration of the second node. For example, the correction system 110 can prioritize network usage for a node with high network capacity (e.g., determined by detecting high network interface bandwidth or low network utilization) and lower memory usage for a node with limited RAM (e.g., determined by querying available memory or system configuration). In this example, the correction system 110 can use the node-specific metrics to guide the reallocation of the data groups 108 during the correction stage. The second scoring function can include a second weight prioritization of the plurality of second resource indicators based at least one second hardware configuration of the at least one second node. The second resource metric can indicate a higher available resource capacity for the at least one data group compared to the plurality of nodes. That is, the correction system 110 can compute a severity score for the second node using weights that reflect its unique hardware resources and workload demands.

In one example, the allocation system 104 can assign data groups B1 and B2 to Node A, B3 and B4 to Node B, B5 and B6 to Node C, and B7 and B8 to Node D. The correction system 110 can determine resource indicators for at least one (e.g., each) node, including memory usage, processor usage, and/or network usage. For Node A, the memory usage can be 70%, the processor usage can be 65%, and the network usage can be 40%. The correction system 110 can compute a resource metric for Node A by applying a node-specific scoring function to the resource indicators. For example, the scoring function for Node A can be defined as:

$$resource metric = ( memory usage * memory weight ) + ( processor usage * processor weight ) + ( network usage * network weight ) .$$

If the memory weight is 0.6, the processor weight is 0.4, and the network weight is 0.0, then the resource metric for Node A can be calculated as:

$$resource metric = ( 70 * 0.6 ) + ( 65 * 0.4 ) + ( 40 * 0. ) = 42 + 26 + 0 = 68$$

Similarly, for Node C, the memory usage can be 85%, the processor usage can be 55%, and the network usage can be 60%. If the memory weight is 0.65, the processor weight is 0.35, and the network weight is 0.0, then the resource metric for Node C can be calculated as:

$$resource metric = ( 85 * 0.65 ) + ( 55 * 0.35 ) + ( 60 * 0. ) = 55.25 + 19.25 + 0 = 74.5$$

The correction system 110 can round or truncate the resource metric as needed for comparison. During the correction stage, the correction system 110 can identify the node with the highest resource metric as the most overloaded node and/or any overloaded node whose resource metric exceeds a predefined capacity threshold (e.g., 80% memory usage, 90% processor usage, 70% network usage, and/or any node-specific resource limit). In this example, Node C can be identified as the most overloaded node because it has the highest resource metric of approximately 74.5. The correction system 110 can evaluate possible data group reallocations from Node C to other nodes by simulating the effect of moving at least one (e.g., each) data group and recalculating the resource metrics for the affected nodes using the same or different scoring function. For example, the correction system 110 can determine that moving data group B6 from Node C to Node D, which can have a lower resource metric and sufficient available capacity, results in the greatest reduction in the maximum resource metric across all nodes. After the move, Node C can host only data group B5, and Node D can host data groups B7, B8, and B6. The correction system 110 can update the resource indicators and resource metrics for Node C and Node D to reflect the new allocation. This process can be repeated, with the correction system 110 selecting the most overloaded node and the data group move in at least one (e.g., each) iteration until all nodes are within capacity and/or a convergence parameter is satisfied.

Performing overloaded_{nodes}=find_overloaded_nodes(node_{loads}, capacityₗᵢₘᵢₜₛ) can include analyzing the resource metric (e.g., severity score) of at least one (e.g., each) node and identifying the node with the highest resource metric value as the most overloaded node. The correction system 110 can identify the at least one node of the plurality of nodes based at least on the resource metric of the at least one node indicating a relative level of capacity (e.g., most-loaded node) compared to at least one other node (e.g., least-loaded node) of the plurality of nodes. The relative level of capacity can include a measure of utilization, availability, and/or load corresponding to the at least one resource indicator. That is, the correction system 110 can perform the find_overloaded_nodes(node_{loads}, capacityₗᵢₘᵢₜₛ) command by selecting the node with the maximum resource metric value from among all nodes. For example, the correction system 110 can determine that node N₁ has a severity score of 67, node N₂ has a severity score of 54, and node N₁ is identified as the most overloaded node because 67 is the highest value. In this example, the overloaded_{nodes} list contains the node(s) with the highest resource metric(s).

Performing bestₘₒᵥₑ=find_best_move(most_{overloaded}_{_{node}}, capacity_{constraints}) can include evaluating possible data group reallocations from the most overloaded node (i.e., the node with the highest resource metric) to other nodes, and selecting the move that would most reduce the resource metric of the most overloaded node. For example, the correction system 110 can consider moving at least one data group from the most overloaded node to at least one compatible node and select the move that results in the greatest decrease in the highest resource metric value. That is, the correction system 110 can perform the find_best_move command by simulating each possible move and choosing the one that minimizes the maximum resource metric after the move. In this example, the compatible node is the node that, after the move, has sufficient capacity.

In some implementations, the bestₘₒᵥₑ function of the correction scheme can include calculating, for at least one (e.g., each) data group (e.g., bucket) assigned to the most overloaded node, a load ratio for multiple resource types (e.g., memory, threads, CPU, or any resource indicator) by dividing the total usage of each resource by the corresponding resource limit for the node:

$${memory}_{ratio} = {total}_{memory} / {memory}_{{limit}_{pernode}}$$

$${thread}_{ratio} = {thread}_{{limit}_{pernode}}$$

The correction system 110 can identify the bottleneck resource for at least one (e.g., each) data group by selecting the maximum load ratio among the considered resources (e.g., max (memoryᵣₐₜᵢₒ, threadᵣₐₜᵢₒ)). The correction system 110 can then sort the candidate data groups (e.g., overloaded buckets) by their bottleneck resource ratio in descending order to prioritize those with the highest impact. For example, the correction system 110 can use a sorting function:

$${sorted}_{bucket} = sorted ( {overloaded}_{buckets} , key = lambda b : b \cdot {get}_{{load}_{ratio ( context )}} , reverse = True )$$

where the sorted function can order the data groups 108 based on a computed key, overloaded_{buckets} can refer to the set of data groups currently assigned to overloaded nodes, lambda b can refer to a function that computes the bottleneck resource ratio for a given data group b in the current context, and reverse can refer to sorting in descending order so that the data group with the highest bottleneck ratio appears first.

The sorted_{bucket} function can order the data groups 108 by the heaviest bottleneck resource first. In this example, the correction system 110 can select the data group with the highest bottleneck resource ratio for potential reallocation. The correction system 110 can then simulate moving this data group to at least one compatible node and evaluate the resulting resource metrics for the nodes involved. The bestₘₒᵥₑ can be selected as the move that results in the greatest reduction in the maximum resource metric (e.g., severity score) across all nodes, thereby providing improved capacity relief for the most overloaded node. The correction scheme can support multi-resource optimization by considering multiple resource constraints simultaneously, achieves maximum and/or improved impact per move, and maintains determinism and efficiency with a single-level sorting operation of O(B log B) complexity (where B can be the number of data groups or buckets). If the input data does not change, the transformation is deterministic, and the same distribution of the data objects 102 to nodes will result.

Performing execute_bucket_move can include updating the node allocations to reflect the transfer of the selected data group from the most overloaded node to the compatible node, and recalculating the resource metrics for both nodes. In some implementations, the at least one data group can be reallocated from an overloaded node of the plurality of nodes to a compatible node of the plurality of nodes (e.g., the updated node allocations 112). The correction system 110 can reallocate a data group (e.g., moving the heaviest bucket) from the most overloaded node to a compatible node determined by comparing resource metrics (e.g., severity scores or capacity relief potential). That is, the correction system 110 can perform the execute_bucket_move command by removing the data group from the allocation of the most overloaded node, adding it to the allocation of the compatible node, and updating the resource metrics accordingly. For example, the correction system 110 can update the severity scores for both nodes after the move. In this example, the correction system 110 can log the move, increment a move counter, and/or proceed to the next iteration of the correction scheme loop. Additionally, the correction system 110 can update, using the correction scheme corresponding to the second phase for a plurality of iterations, a plurality of allocations (e.g., to create the updated node allocations 112) of the plurality of data groups 108 among the plurality of nodes until the convergence parameter is satisfied. That is, execute_bucket_move can be performed repeatedly until no node has a resource metric higher than all others, no valid moves remain, and/or the maximum number of iterations is reached.

In some implementations, when new data objects are received by system 100, the allocation system 104 can assign at least one (e.g., each) new data object to a data group using the same deterministic mapping function as used for existing data objects. For example, the allocation system 104 can compute a bucket identifier for at least one (e.g., each) new data object using a hash function and/or assign the data object to the corresponding data group. The allocation system 104 can update the metadata for the affected data group to reflect the addition of the new data object. The correction system 110 can then update the resource indicators for the node hosting the affected data group by recalculating memory usage, processor usage, and/or network usage. The correction system 110 can recompute the resource metric for the node using the node-specific scoring function. If the updated resource metric exceeds a capacity threshold or increases the imbalance among nodes, the correction system 110 can initiate the correction stage to evaluate possible reallocations (e.g., the updated node allocations 112) of the data groups 108 and maintain balanced resource utilization.

In another example, the allocation system 104 can process a batch of new data objects by assigning at least one (e.g., each) data object to a data group and updating the node allocations accordingly. The correction system 110 can aggregate the resource usage of the new data objects and update the resource indicators for the affected nodes. The correction system 110 can determine whether the addition of the new data objects results in any node exceeding its resource limits and/or is overloaded. If so, the correction system 110 can identify the most overloaded node based on the resource metric and select data groups for reallocation to compatible nodes. The correction system 110 can perform the correction scheme loop, updating node allocations and resource metrics iteratively until the convergence parameter is satisfied.

In some implementations, when a new node (e.g., topology change) is added to the system 100, the allocation system 104 can update the mapping of the data groups 108 to nodes to include the new node. For example, the allocation system 104 can recompute the assignment of the data groups 108 using the consistent hashing algorithm, which can result in the reassignment of a subset of data groups to the new node. The allocation system 104 can update the node allocations to reflect the new distribution. The correction system 110 can update the resource indicators for the new node and any affected existing nodes by recalculating memory usage, processor usage, and/or network usage based on the new data group assignments. The correction system 110 can recompute the resource metrics for the nodes and determine whether further reallocation is needed to maintain balanced resource utilization.

In another example, the allocation system 104 can assign a portion of the existing data groups to the new node based on the updated consistent hashing ring and/or mapping function. The correction system 110 can monitor the resource usage of the new node as it begins to manage its assigned data groups. The correction system 110 can compare the resource metrics of all nodes and identify any imbalances resulting from the addition of the new node. If necessary, the correction system 110 can initiate the correction stage to reallocate data groups among nodes.

In some implementations, at least one (e.g., each) of the plurality of nodes can operate independently from other nodes of the plurality of nodes. That is, the nodes can siloed in that at least one (e.g., each) node can function, store, and execute without contingencies on other nodes. For example, a plurality of first data groups allocated to a first node of the plurality of nodes can be disjoint (e.g., do not overlap) from a plurality of second data groups allocated to a second node of the plurality of nodes. In some implementations, at least one (e.g., each) node can cache, store, and/or process only the data groups assigned to that node, such that the memory usage, cache state, and/or request handling for each node depend on its own data groups 108. That is, at least one (e.g., each) node can load, access, and/or manage its assigned data groups 108 and does not require knowledge of and/or access to the entire dataset or the data groups 108 assigned to other nodes. This configuration can allow system 100 to scale to larger datasets without increasing per-node resource requirements, since at least one (e.g., each) node manages a subset of the data. The assignment of the data groups 108 can be adapted based on the heterogeneous capacities of the nodes, such as memory size or processing power, without requiring global coordination or state sharing among all nodes.

In some implementations, system 100 can perform allocation and correction operations with bounded computational complexity. During the first phase, the system 100 can perform shard-to-bucket hashing with O(S) complexity, where S can be the number of data objects. System 100 can construct a virtual node ring with O(V) complexity, where V can be the number of virtual nodes (e.g., V=N*NUM_VNODES_PER_NODE, where N can be the number of nodes). Sorting the virtual ring can be performed with O(V log V) complexity, and bucket-to-node assignment can be performed with O(B log V) complexity, where B can be the number of data groups 108. The total time complexity for the first phase can be O(S+V log V+B log V), which can be near-linear in S as S>>V>>B in practice. During the second phase, the system 100 can perform a greedy correction process with up to B iterations, where each iteration can include node load calculation (O(B)), move selection (O(B*N)), and overloaded node sorting (O(N log N)). The total time complexity for the second phase can be O(B*(B+B*N+N log N)), which can be O(B²*N) in the worst case and O(B*N) in typical cases when early convergence is achieved. The overall algorithmic complexity for system 100 can be O(S+V log V+B log V+B²*N) in the worst case and O(S+V log V+B log V+B*N) in typical cases.

In some implementations, the system 100 can also provide technical improvements in space complexity and operational efficiency. The space required for shard storage (e.g., the data objects 102) can be O(S), virtual ring storage can be O(V), bucket metadata can be O(B), and node load tracking can be O(N), resulting in a total space complexity of O(S+V+B+N), which can be approximated as O(S+V) when S>>B, N. With regards to move operations during topology changes, the system 100 can reduce the number of migration operations from

$$O ( \frac{s}{N} )$$

individual data object moves in traditional approaches to

$$O ( \frac{B}{N} )$$

data group moves, where S can be the number of data objects, B can be the number of data groups, and N can be the number of nodes. For example, with S=10,000 data objects, B=256 data groups, and N=4 nodes, the system 100 can require approximately 39 times fewer move operations and/or 10-40× fewer move operations compared to traditional approaches. This bucket-based approach can reduce operational complexity by migrating the data groups 108 rather than the individual data objects 102 (e.g., while maintaining balanced resource utilization across nodes).

In some implementations, the system 100 can implement multiple techniques for selecting the data groups 108 for migration during the correction stage. For example, the system 100 can select at least one (e.g., each) data group for migration by identifying the bottleneck resource for the most overloaded node, such as the resource with the highest utilization ratio (e.g., memory or threads). In another example, system 100 can select the data groups 108 for migration by evaluating both the relief provided to the source node and the impact on the remaining capacity on the target node. For example, the correction system 110 can simulate moving a data group from an overloaded node to a compatible node and determine the effect on the resource metrics of both nodes. In yet another example, system 100 can select the data groups 108 for migration by analyzing the potential for cascading overloads, such as by avoiding moves that would result in the target node exceeding its resource limits.

It should be understood that the correction scheme can cause a distribution and/or allocation of the data groups 108 to the corresponding node. However, in some implementations, the correction system 110 can use the updated node allocations 112 of the data groups 108 to distribute data across nodes (in separate operations). That is, while the correction scheme updates the allocation mapping, the actual transfer or migration of data can be performed as a distinct operation based on the updated node allocations 112, in some implementations. For example, after determining a valid bucket move, the correction system 110 can update the mapping of a data group 108 from a source node to a destination node. The correction system 110 can cause distribution of data by initiating transfer operations for the data associated with the reallocated data group 108, based on the updated node allocations 112 resulting from the correction stage. In some implementations, the correction system 110 can apply the allocation of data groups 108 to nodes to control the physical storage of data within the system 100. The correction system 110 can perform and/or otherwise execute migration actions for the data groups 108 according to the allocation state (e.g., current allocation mapping, previous allocation mapping, planned allocation mapping) determined by the correction scheme loop. The correction system 110 can perform these actions in response to resource metrics and convergence safeguards, using the allocation to direct data movement and resource balancing among the nodes.

In some implementations, the system 100 can also implement bucket selection strategies that account for multiple resource constraints simultaneously. For example, system 100 can use a Pareto-optimal selection approach, where a data group move is selected if it provides improvement across at least one resource dimension (e.g., memory, threads, CPU) without causing degradation in another. In some implementations, the correction system 110 can score nodes using a composite function that accounts for memory usage, processor usage, and/or thread utilization, and select data group moves that improve the overall resource balance. In another example, the system 100 can implement a balance optimization strategy, where the correction system 110 continues to redistribute the data groups 108 among nodes even after all nodes are within expected capacity, such as by tracking resource utilization and reallocating the data groups 108 to achieve a more balanced distribution. For example, the correction system 110 can monitor the variance in resource metrics across nodes and perform additional reallocations to reduce resource imbalance.

In some implementations, system 100 can determine the number of correction iterations or stopping conditions using a three-layer termination system. For example, the correction system 110 can terminate the correction process when all nodes are within capacity (success termination), when no valid moves remain (feasibility termination), and/or when a maximum number of iterations is reached (safety termination). In some implementations, the correction system 110 can set the iteration limit adaptively based on workload stress levels. For example, the correction system 110 can calculate the ratio of total capacity violations to total system capacity and set the iteration limit to 50 iterations when the ratio is less than 10%, to 100 iterations when the ratio is between 10% and 30%, and/or to a full iteration limit when the ratio exceeds 30%. The correction system 110 can update the iteration limit dynamically as the workload stress level changes.

In some implementations, the system 100 can monitor progress and detect stagnation during the correction stage. For example, the correction system 110 can track the improvement rate in resource metrics over recent iterations and terminate the correction process when the improvement rate falls below a threshold. For example, the correction system 110 can calculate the percentage decrease in resource metric violations for each iteration and terminate the process if the decrease is less than 1% over a three-iteration window. In another example, the correction system 110 can compare the resource metric values from the current iteration to those from previous iterations and terminate the process when the difference is below a specified threshold. The correction system 110 can use these progress tracking and stagnation detection techniques to determine when to stop the correction process.

In some implementations, system 100 can maintain a cached view of node loads to reduce computational complexity during the correction stage. For example, the correction system 110 can update node load values incrementally as the data groups 108 are moved, rather than recalculating all node loads from scratch in at least one (e.g., each) iteration. When a data group is reallocated from one node to another, the correction system 110 can update the resource metrics for only the affected nodes. For example, after moving a data group from node N₁ to node N₂, the correction system 110 can update the memory usage, processor usage, and/or network usage values for N₁ and N₂ without recomputing the metrics for all nodes. This incremental load calculation caching can reduce the per-iteration complexity from O(B*N) to O(N), resulting in a total complexity of O(B*N) for the correction stage.

In some implementations, the system 100 can pre-filter candidate target nodes based on capacity constraints before evaluating potential data group moves. For example, the correction system 110 can exclude nodes that do not have sufficient available capacity to accept a data group from the set of candidate target nodes. For example, the correction system 110 can compare the projected resource usage of at least one (e.g., each) node to its capacity limit and remove nodes that would exceed the limit if a data group were added. This smart node filtering can reduce the number of nodes considered in each iteration from N to a smaller subset, such as 50-70% of the total nodes, depending on the current load and capacity distribution. The correction system 110 can then evaluate potential moves only for the remaining candidate nodes, reducing the search space and/or improving computational efficiency (e.g., in examples with tight capacity constraints or highly loaded clusters).

In some implementations, the system 100 can configure the number of data groups (e.g., buckets) used for allocation based on workload characteristics. For example, the correction system 110 can determine the coefficient of variation (CV) of shard weights and select the bucket count accordingly. For example, the system 100 can use 128 buckets (e.g., the data groups 108) for uniform workloads where the CV is less than 1.0, 256 buckets for workloads with medium variability where the CV is less than 3.0, 512 buckets for high-variability workloads where the CV is less than 10.0, and/or 1024 buckets for workloads with extreme variability where the CV is greater than or equal to 10.0. The bucket count can be configured prior to allocation and/or adjusted as part of a workload-aware optimization process. Using more buckets for high-variability workloads can provide finer migration granularity and more precise load balancing, while fewer buckets can be used for uniform workloads to improve efficiency.

In some implementations, the system 100 can dynamically adjust the bucket count during correction scheme execution based on observed performance metrics. For example, the correction system 110 can monitor the trade-off between load balancing quality, as measured by the Gini coefficient, and/or migration overhead. The correction system 110 can increase the bucket count (e.g., data group count) when poor load balancing quality is observed with low migration activity, and/or decrease the bucket count when good load balancing quality is observed with high migration activity. The adaptive logic can maintain performance balance through self-tuning, allowing the system 100 to respond to changing workload patterns without requiring manual configuration and/or prior knowledge of workload characteristics. The adjustment of bucket count can affect the consistency of the allocation and/or correction scheme across various cycles.

In some implementations, the system 100 can assign the data groups 108 (e.g., buckets) to nodes using a two-tier assignment technique that accounts for bucket weights. For example, the correction system 110 can identify the data groups 108 with aggregate resource requirements above a configurable threshold as heavy buckets. The correction system 110 can assign normal buckets to nodes using standard consistent hashing to maintain migration efficiency, while assigning heavy buckets using a load-aware placement strategy that selects the least-loaded node based on current resource metrics. The approach can prevent clustering of heavy buckets on a single node, improve the quality of the initial distribution, and/or reduce the number of correction iterations required in subsequent phases. For example, the correction system 110 can evaluate the resource usage of at least one (e.g., each) node and assign (e.g., reallocate, the updated node allocations 112) a heavy bucket to the node with the lowest projected resource utilization, while continuing to use hash-based assignment for all other buckets.

In some implementations, the system 100 can configure the number of virtual nodes per physical node based on the size of the cluster. For example, the allocation system 104 can assign 64 virtual nodes to each physical node in clusters with four or fewer nodes to achieve high distribution quality, 40 virtual nodes per physical node in clusters with five to eight nodes, 24 virtual nodes per physical node in clusters with nine to sixteen nodes, and/or 16 virtual nodes per physical node in clusters with more than sixteen nodes. The allocation system 104 can adjust the virtual node density dynamically as the cluster size changes. The adaptive scaling can improve the balance between hash ring distribution quality and computational overhead.

In some implementations, the system 100 can distribute virtual nodes among physical nodes in proportion to node capacity. For example, the correction system 110 can assign (e.g., reallocate) a greater number of virtual nodes to physical nodes with higher memory, processor, and/or network capacity, and fewer virtual nodes to nodes with lower capacity. The correction system 110 can determine node capacity based on resource indicators such as total memory, CPU cores, or network bandwidth. The capacity-proportional allocation can increase the likelihood that nodes with greater resources receive more data group assignments during consistent hashing, resulting in improved load distribution in heterogeneous cluster environments where nodes can have significantly different resource capacities.

In some implementations, the system 100 can include a resource type extensibility framework that allows the definition of multiple resource types for constraint-based allocation and correction. For example, the correction system 110 can define a resource type by specifying a resource name (e.g., CPU cores, network bandwidth, storage I/O, GPU memory), a measurement unit (e.g., gigabytes, megabits per second, IOPS), and/or a constraint behavior (e.g., hard constraint, soft constraint, elastic constraint). The correction system 110 can process resource indicators for at least one (e.g., each) defined resource type and apply corresponding constraint logic during allocation and correction. The resource type extensibility framework can support the addition of new resource types without requiring modification of the allocation or correction algorithms. The correction system 110 can use the defined resource types to evaluate node capacity, determine constraint violations, and/or perform allocation and correction operations based on the characteristics of each resource type.

In some implementations, the system 100 can implement a hierarchical constraint system that differentiates between hard and soft constraints for multiple resource types. For example, the correction system 110 can classify memory limits as hard constraints, which can be strictly enforced to prevent conditions such as out-of-memory errors, and/or classify network bandwidth as a soft constraint, which can be preferentially enforced but allow temporary violations. The correction system 110 can prioritize correction operations by first resolving violations of hard constraints before addressing violations of soft constraints. For example, the correction system 110 can reallocate the data groups 108 to ensure that no node exceeds its memory capacity before attempting to balance network bandwidth usage. The prioritized correction process can maintain system functionality by enforcing hard constraints while allowing temporary reductions in performance for resource types governed by soft constraints.

In some implementations, the system 100 can select a hash function for data group assignment based on workload distribution characteristics. For example, the allocation system 104 can analyze the coefficient of variation of shard weights and select a fast multiplicative hash function for uniform workloads, a provided hash function for workloads with moderate variation, and/or a longer hash function for workloads with high variation to achieve superior distribution quality. The allocation system 104 can perform adaptive hash selection by evaluating the distribution of resource requirements and/or determining an appropriate hash function for the current workload pattern. The hash function selection process can balance hash quality against computational overhead, allowing the system 100 to maintain data group assignment for uniform workloads and improve distribution quality for workloads with significant variability.

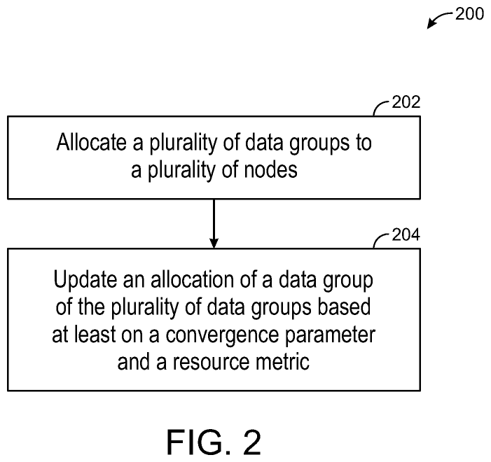

With reference to FIG. 2, FIG. 2 shows an example flow diagram illustrating a method for load-balanced data groups in distributed nodes in an allocation pipeline, in accordance with some implementations of the present disclosure. This and other arrangements are provided as examples. Alternative arrangements, elements (such as machines, interfaces, functions, orders, or groupings), and configurations can be used in addition to or instead of those shown. Elements described herein can be implemented as discrete or distributed functional entities, alone or in combination, in any configuration or location. Functions can be performed by hardware, firmware, and/or software, for example, using one or more processing circuits executing instructions stored in one or more memory circuits. In some implementations, the systems and methods can use one or more language models, one or more computing devices, and/or one or more data centers.

Referring now to FIG. 2, each block of method 200 includes a computing process that can be performed using any combination of hardware, firmware, and/or software. For example, functions can be carried out using one or more processing circuits executing instructions stored in memory. FIG. 2 is a flow diagram showing a method 200 for allocating, updating, and/or applying operations (among other operations), in accordance with some implementations of the present disclosure. The method can be embodied as computer-usable instructions stored on computer storage media. The method can be provided as a standalone application, a service or hosted service, a microservice via an application programming interface (API), and/or a plug-in to another product, among other examples. Method 200 is described by way of example with respect to the system of FIG. 1, but can additionally or alternatively be executed by any one system or combination of systems, including those described herein.

The method 200, at block 202, includes allocating, using an allocation scheme corresponding to a first phase, a plurality of data groups to a plurality of nodes. For example, processing circuits can apply an allocation scheme to a plurality of data groups to cause an allocation of the plurality of data groups to a plurality of nodes.

The method 200, at block 204 includes updating, using a correction scheme corresponding to a second phase, at least one allocation of at least one data group of the plurality of data groups based at least on a convergence parameter and a resource metric. The resource metric can correspond to at least one resource indicator of a hardware configuration detected from at least one node of the plurality of nodes based at least on performance of at least one node command. For example, processing circuits can apply a correction scheme to the plurality of nodes to cause an update in at least one allocation of at least one data group of the plurality of data groups based at least on a convergence parameter and a resource metric.

In some implementations, updating the at least one allocation of the at least one data group can include determining a resource indicator for each of the plurality of nodes based at least on the hardware configuration. In some implementations, the hardware configuration can correspond to a memory usage. In some implementations, the hardware configuration can correspond to a processor usage. In some implementations, the hardware configuration can correspond to a network usage. In some implementations, the hardware configuration can correspond to an application value. In some implementations, the hardware configuration can correspond to a thread value. In some implementations, the hardware configuration can correspond to an API call value for each node of the plurality of nodes.

In some implementations, updating the at least one allocation of the at least one data group can include identifying the at least one node of the plurality of nodes based at least on the resource metric of the at least one node. In some implementations, the resource metric can indicate a relative level of capacity compared to at least one other node of the plurality of nodes.

In some implementations, the relative level of capacity can include a measure of utilization. In some implementations, the relative level of capacity can include availability. In some implementations, the relative level of capacity can include load corresponding to the at least one resource indicator. In some implementations, the at least one data group can be reallocated from an overloaded node of the plurality of nodes to a compatible node of the plurality of nodes. In some implementations, the compatible node can be identified based at least on a second resource metric of the compatible node. In some implementations, the second resource metric can indicate a higher available resource capacity for the at least one data group compared to the plurality of nodes.

In some implementations, updating the at least one allocation of the at least one data group of the plurality of data groups can include updating, using the correction scheme corresponding to the second phase for a plurality of iterations. In some implementations, updating can include a plurality of allocations of the plurality of data groups among the plurality of nodes until the convergence parameter is satisfied. In some implementations, the convergence parameter can correspond to an iteration limit corresponding to reallocation. In some implementations, the convergence parameter can correspond to an iteration parameter corresponding to a decrease in a sum of a plurality of resource metrics exceeding a resource parameter. In some implementations, the convergence parameter can correspond to at least one termination condition.

In some implementations, determining the resource metric of the at least one node can include applying a first scoring function to a plurality of first resource indicators of the at least one node. In some implementations, determining a second resource metric of at least one second node can include applying a second scoring function to a plurality of second resource indicators of the at least one second node. In some implementations, the first scoring function can include a first weight prioritization of the plurality of first resource indicators based at least one first hardware configuration of the at least one node. In some implementations, the second scoring function can include a second weight prioritization of the plurality of second resource indicators based at least one second hardware configuration of the at least one second node.

In some implementations, detecting the at least one first hardware configuration can include accessing an operating system (OS) or hardware interface of the at least one node. In some implementations, detecting can include performing the at least one node command. In some implementations, the at least one first hardware configuration can be based at least on telemetry data of the at least one node returned from the performance of the at least one node command.

In some implementations, each of the plurality of nodes can operate independently from other nodes of the plurality of nodes. In some implementations, a plurality of first data groups allocated to a first node of the plurality of nodes can be disjoint from a plurality of second data groups allocated to a second node of the plurality of nodes. In some implementations, allocating the plurality of data groups to the plurality of nodes can include assigning a plurality of data objects into the plurality of data groups. In some implementations, the plurality of data groups can satisfy a size parameter.

In some implementations, allocating the plurality of data groups to the plurality of nodes can include aggregating a plurality of weights of the plurality of data objects of at least one of the plurality of data groups to generate a plurality of aggregated weights. In some implementations, each aggregated weight can correspond to a corresponding data group of the plurality of data groups. In some implementations, allocating can include generating an ordered structure including a plurality of virtual nodes. In some implementations, at least one virtual node can correspond to at least one of the plurality of nodes. In some implementations, the ordered structure can be used to allocate the plurality of data groups to the plurality of nodes based at least on the plurality of aggregated weights.

In some implementations, the correction scheme can correspond to a plurality of reallocation operations to reallocate at least one of the plurality of data groups among the plurality of nodes based at least on a plurality of resource metrics. In some implementations, the allocation scheme can correspond to a plurality of allocation operations to (i) generate the plurality of data groups using a plurality of data objects, and/or (ii) allocate the plurality of data groups based at least on at least one mapping function.

FIG. 3 illustrates an example system 300 for allocating and correcting data group allocations among nodes, in accordance with some implementations of the present disclosure. The allocation system 104 can generate initial node allocations by assigning a plurality of data groups 108a (e.g., DG1, DG10, DG12) to node 302, a plurality of data groups 108b (e.g., DG2, DG5, DG9, DG11) to node 304, a plurality of data groups 108c (e.g., DG3, DG6, DG7, DG8, DG14) to node 306, and a plurality of data groups 108d (e.g., DG4, DG13, DG15) to node 308. The initial allocations are shown by solid arrows from the allocation system 104 to at least one (e.g., each) node. Each node 302, 304, 306, and 308 can store or manage the data groups assigned to it, as indicated by the respective groupings within each node box. In some implementations, the correction system 110 can receive the initial node allocations of the data groups 108a, 108b, 108c, and 108d and determine updated node allocations of the data groups 108e, 108b, 108f, and 108g based on resource metrics and convergence parameters. For example, after correction, node 302 can be assigned data groups DG1, DG6, DG10, DG12 as shown in updated allocation of the data groups 108e. Node 304 can be assigned DG2, DG5, DG9, DG11 (unchanged) as shown in the allocation of the data groups 108b. Node 306 can be assigned DG3, DG8, DG14 as shown in updated allocation of the data groups 108f. Node 308 can be assigned DG4, DG7, DG13, DG15 as shown in updated allocation of the data groups 108g. The dashed arrows indicate the reallocation of data groups from the initial node allocations to the updated node allocations as determined by the correction system 110. The correction system 110 can use resource metrics, such as memory usage, processor usage, and/or network usage, to identify overloaded nodes and compatible nodes, and can iteratively reallocate data groups to achieve balanced resource utilization across nodes. Example system 300 can depict the allocation stage of the allocation pipeline.

FIG. 4 illustrates an example system 400 depicting resource metrics and resource usage values for a plurality of nodes, in accordance with some implementations of the present disclosure. Node A 402 can include a resource metric of 68, memory usage of 70%, processor usage of 40%, and network usage of 40%. Node B 404 can include a resource metric of 66, memory usage of 60%, processor usage of 75%, and network usage of 50%. Node C 406 can include a resource metric of 73, memory usage of 85%, processor usage of 55%, and network usage of 60%. Node D 408 can include a resource metric of 54, memory usage of 50%, processor usage of 60%, and network usage of 40%. In some implementations, the correction system 110 can determine the resource metric for at least one (e.g., each) node 402, 404, 406, 408 by applying a scoring function to the memory usage, processor usage, network usage values, and/or other resource indicators for that node. The resource metric can be used to identify the most overloaded node (e.g., Node C 406 with a resource metric of 73) and to guide the reallocation of data groups (e.g., during the correction stage of the allocation pipeline).

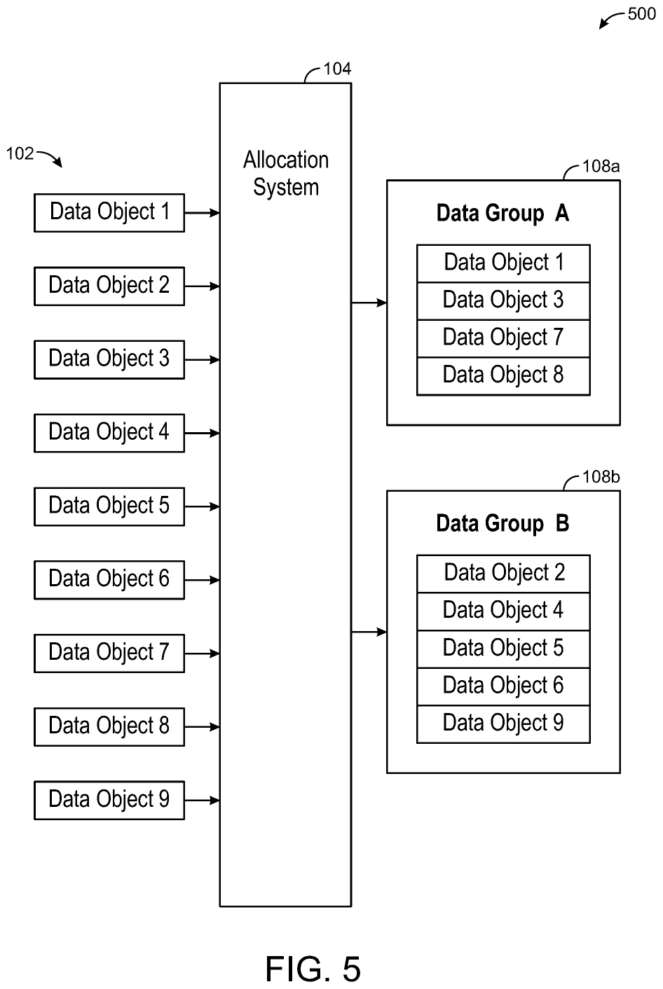

FIG. 5 illustrates an example system 500 for grouping data objects into data groups using an allocation system 104, in accordance with some implementations of the present disclosure. The allocation system 104 can receive a plurality of data objects 102, such as Data Object 1 through Data Object 9, and assign each data object to at least one data group. For example, as shown, Data Group A can include Data Object 1, Data Object 3, Data Object 7, and Data Object 8, and Data Group B can include Data Object 2, Data Object 4, Data Object 5, Data Object 6, and Data Object 9. The allocation system 104 can apply a mapping function, such as a hash function and/or partitioning rule, to determine the assignment of each data object to a data group. Each data group 108a, 108b can represent a logical grouping of data objects for subsequent allocation to nodes and/or for further processing. Example system 500 can depict the group stage of the allocation pipeline.

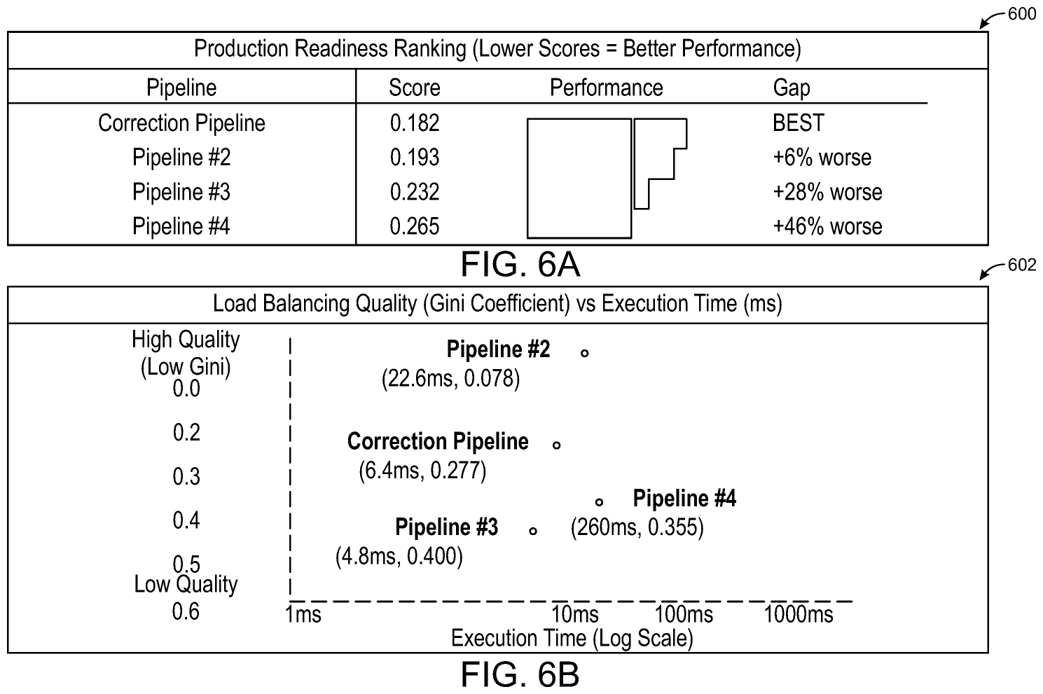

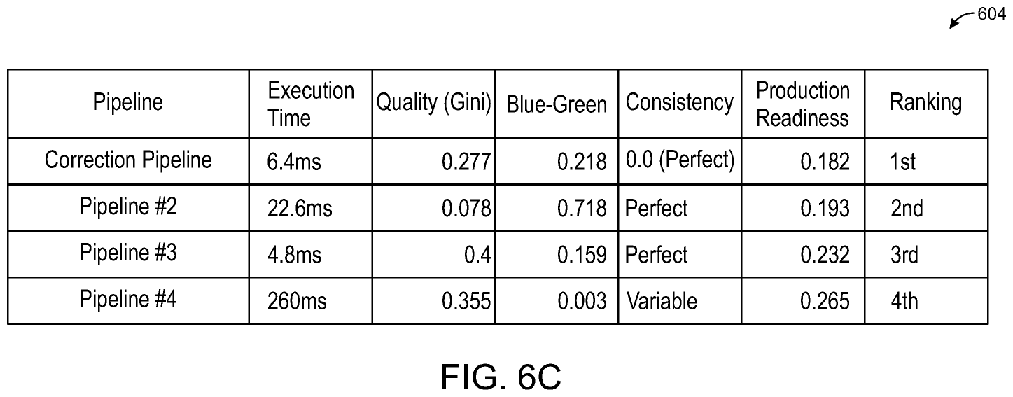

FIG. 6A illustrates a readiness ranking table 600 for multiple allocation and correction pipelines, where lower scores can include better performance, in accordance with some implementations of the present disclosure. The readiness ranking table 600 includes a correction pipeline, which can correspond to the system 100 (e.g., implementing allocation and correction), and three other pipelines, labeled Pipeline #2, Pipeline #3, and Pipeline #4. The correction pipeline can achieve a score of 0.182. Pipeline #2 can have a score of 0.193, Pipeline #3 can have a score of 0.232, and Pipeline #4 can have a score of 0.265. The performance gap column indicates that Pipeline #2 is 6% worse than the correction pipeline, Pipeline #3 is 28% worse, and Pipeline #4 is 46% worse. The performance bar chart visually represents the relative performance of each pipeline. The scores can be based on aggregate metrics such as execution time, load balancing quality, consistency (e.g., across executions), and/or migration overhead, measured across various datasets and workload patterns.

In some implementations, the correction pipeline can be evaluated across production environments with different workload characteristics, including well-balanced, uniform, variable, and high-variability workloads. For example, the correction pipeline can achieve execution times ranging from 5.67 ms to 7.41 ms and load balancing performance (e.g., calculated as Gini coefficients of the weight distribution allocated per node) from 0.053 to 0.705 across environments. The correction pipeline can maintain execution times and Gini coefficients within these ranges under varying memory and thread variability, as indicated by coefficients of variation for memory and thread usage in the test environments. In comparison, Pipeline #2 (e.g., Best-Fit-Decreasing Greedy) can achieve a production readiness score of 0.193 versus 0.182 for the correction pipeline, Pipeline #3 (e.g., ConsistentHashing) can achieve 0.232 versus 0.182, and Pipeline #4 (e.g., SimulatedAnnealing) can achieve 0.311 versus 0.182. The correction pipeline can achieve the lowest production readiness score across all tested workload complexities.

FIG. 6B illustrates a performance scatter plot 602 comparing load balancing quality and execution time for multiple allocation and correction pipelines, in accordance with some implementations of the present disclosure. The vertical axis of the performance scatter plot 602 represents load balancing quality as measured by the Gini coefficient, where lower values indicate higher quality. The horizontal axis represents execution time in milliseconds on a logarithmic scale. The performance scatter plot 602 includes data points for the correction pipeline, pipeline #2, pipeline #3, and pipeline #4. Pipeline #2 can be represented by a data point at (22.6 ms, 0.078), the correction pipeline by a data point at (6.4 ms, 0.277), pipeline #3 by a data point at (4.8 ms, 0.400), and pipeline #4 by a data point at (260 ms, 0.355). Each data point can correspond to the measured execution time and Gini coefficient for the respective pipeline on production datasets. The performance scatter plot 602 visually demonstrates the trade-off between execution time and load balancing quality for each pipeline, with the correction pipeline shown to achieve a balance between execution time and Gini coefficient compared to the other pipelines.

FIG. 6C illustrates an execution time versus quality matrix 604 for multiple allocation and correction pipelines, in accordance with some implementations of the present disclosure. The matrix 604 includes columns for pipeline name, execution time, load balancing quality as measured by the Gini coefficient, blue-green deployment impact (e.g., during deployment the data object to node distribution changes can be low quality, thus, algorithms that minimize changes can be ranked higher), consistency of allocation (e.g., across executions), production readiness, and ranking. The correction pipeline can achieve an execution time of 6.4 ms, a Gini coefficient of 0.277, a blue-green value of 0.218, a consistency value of 0.0 (Perfect), a production readiness score of 0.182, and a ranking of 1st. Pipeline #2 can achieve an execution time of 22.6 ms, a Gini coefficient of 0.078, a blue-green value of 0.718, a consistency value of Perfect, a production readiness score of 0.193, and a ranking of 2nd. Pipeline #3 can achieve an execution time of 4.8 ms, a Gini coefficient of 0.4, a blue-green value of 0.159, a consistency value of Perfect, a production readiness score of 0.232, and a ranking of 3rd. Pipeline #4 can achieve an execution time of 260 ms, a Gini coefficient of 0.355, a blue-green value of 0.003, a consistency value of Variable, a production readiness score of 0.265, and a ranking of 4th. The matrix 604 demonstrates that the correction pipeline is the pipeline to achieve sub-10 ms execution time with both good quality (Gini coefficient) and perfect consistency, as measured across production datasets.

The present techniques will be better understood with reference to the following enumerated clauses:

Clause 1. A method, comprising: allocating, using an allocation scheme corresponding to a first phase, a plurality of data groups to a plurality of nodes; and updating, using a correction scheme corresponding to a second phase, at least one allocation of at least one data group of the plurality of data groups based at least on a convergence parameter and a resource metric, the resource metric corresponding to at least one resource indicator of a hardware configuration detected from at least one node of the plurality of nodes based at least on performance of at least one node command; wherein the method is performed using one or more processors.

Clause 2. The method of clause 1, wherein to update the at least one allocation of the at least one data group comprises: determining a resource indicator for each of the plurality of nodes based at least on the hardware configuration corresponding to at least one of a memory usage, a processor usage, a network usage, an application value, a thread value, or an API call value for each node of the plurality of nodes.

Clause 3. The method of any of clauses 1-2, wherein to update the at least one allocation of the at least one data group comprises: identifying the at least one node of the plurality of nodes based at least on the resource metric of the at least one node indicating a relative level of capacity compared to at least one other node of the plurality of nodes.

Clause 4. The method of any of clauses 1-3, wherein the relative level of capacity comprises a measure of utilization, availability, or load corresponding to the at least one resource indicator.

Clause 5. The method of any of clauses 1-4, wherein the at least one data group is reallocated from an overloaded node of the plurality of nodes to a compatible node of the plurality of nodes, the compatible node identified based at least on a second resource metric of the compatible node, the second resource metric indicating a higher available resource capacity for the at least one data group compared to the plurality of nodes.

Clause 6. The method of any of clauses 1-5, wherein to update the at least one allocation of the at least one data group of the plurality of data groups comprises: updating, using the correction scheme corresponding to the second phase for a plurality of iterations, a plurality of allocations of the plurality of data groups among the plurality of nodes until the convergence parameter is satisfied.

Clause 7. The method of any of clauses 1-6, wherein the convergence parameter corresponds to at least one of (i) an iteration limit corresponding to reallocation, (ii) an iteration parameter corresponding to a decrease in a sum of a plurality of resource metrics exceeding a resource parameter, (iii) at least one termination condition.

Clause 8. The method of any of clauses 1-7, further comprising: determining the resource metric of the at least one node based at least on applying a first scoring function to a plurality of first resource indicators of the at least one node; and determining a second resource metric of at least one second node based at least on applying a second scoring function to a plurality of second resource indicators of the at least one second node; wherein the first scoring function comprises a first weight prioritization of the plurality of first resource indicators based at least one first hardware configuration of the at least one node, and wherein the second scoring function comprises a second weight prioritization of the plurality of second resource indicators based at least one second hardware configuration of the at least one second node.

Clause 9. The method of any of clauses 1-8, further comprising: detect, by accessing an operating system (OS) or hardware interface of the at least one node and performing the at least one node command, the at least one first hardware configuration based at least on telemetry data of the at least one node returned from the performance of the at least one node command.

Clause 10. The method of any of clauses 1-9, wherein each of the plurality of nodes operate independently from other nodes of the plurality of nodes, and wherein a plurality of first data groups allocated to a first node of the plurality of nodes is disjoint from a plurality of second data groups allocated to a second node of the plurality of nodes.

Clause 11. The method of any of clauses 1-10, wherein to allocate the plurality of data groups to the plurality of nodes comprises: assigning a plurality of data objects into the plurality of data groups, wherein the plurality of data groups satisfies a size parameter.

Clause 12. The method of any of clauses 1-11, wherein to allocate the plurality of data groups to the plurality of nodes comprises: aggregating a plurality of weights of the plurality of data objects of at least one of the plurality of data groups to generate a plurality of aggregated weights, each aggregated weight corresponding to a corresponding data group of the plurality of data groups; and generating an ordered structure comprising a plurality of virtual nodes, at least one virtual node corresponding to at least one of the plurality of nodes, the ordered structure used to allocate the plurality of data groups to the plurality of nodes based at least on the plurality of aggregated weights.

Clause 13. The method of any of clauses 1-12, wherein the correction scheme corresponds to a plurality of reallocation operations to reallocate at least one of the plurality of data groups among the plurality of nodes based at least on a plurality of resource metrics.

Clause 14. The method of any of clauses 1-13, wherein the allocation scheme corresponds to a plurality of allocation operations to (i) generate the plurality of data groups using a plurality of data objects and (ii) allocate the plurality of data groups based at least on at least one mapping function.

Clause 15. A system, comprising: at least one processor to execute operations comprising: apply an allocation scheme to a plurality of data groups to cause an allocation of the plurality of data groups to a plurality of nodes; and apply a correction scheme to the plurality of nodes to cause an update in at least one allocation of at least one data group of the plurality of data groups based at least on a convergence parameter and a resource metric, the resource metric corresponding to at least one resource indicator of a hardware configuration of at least one node of the plurality of nodes.

Clause 16. The system of clause 15, wherein the operations, when executed by the at least one processor, further cause the at least one processor to: determine a resource indicator for each of the plurality of nodes based at least on the hardware configuration corresponding to at least one of a memory usage, a processor usage, a network usage, an application value, a thread value, or an API call value for each node of the plurality of nodes.

Clause 17. The system of any of clauses 15-16, wherein the operations, when executed by the at least one processor, further cause the at least one processor to: identify the at least one node of the plurality of nodes based at least on the resource metric of the at least one node indicating a relative level of capacity compared to at least one other node of the plurality of nodes.

Clause 18. The system of any of clauses 15-17, wherein the relative level of capacity comprises a measure of utilization, availability, or load corresponding to the at least one resource indicator.

Clause 19. The system of any of clauses 15-18, wherein the at least one data group is reallocated from an overloaded node of the plurality of nodes to a compatible node of the plurality of nodes, the compatible node identified based at least on a second resource metric of the compatible node, the second resource metric indicating a higher available resource capacity for the at least one data group compared to the plurality of nodes.

Clause 20. A non-transitory computer-readable medium storing instructions that, when executed by at least one processor, cause the at least one processor to perform operations comprising: allocate, using an allocation scheme corresponding to a first phase, a plurality of data groups to a plurality of nodes; and update, using a correction scheme corresponding to a second phase, at least one allocation of at least one data group of the plurality of data groups based at least on a convergence parameter and a resource metric, the resource metric corresponding to at least one resource indicator of a hardware configuration of at least one node of the plurality of nodes.

The foregoing disclosure can be implemented using machine-readable instructions, including instructions executable by processing circuitry of one or more devices. Program modules can include routines, processes, subprograms, data structures, and/or other code configured to perform operations, control components, and/or process information. The disclosure can be implemented in a variety of computing environments, including but not limited to, servers, workstations, general-purpose computers, embedded devices, mobile computing devices, networked computing devices, client systems, gateway devices, routers, and/or combinations thereof. The implementation can use hardware, firmware, software, and/or any combination of these. Hardware implementations can include logic circuits, application-specific integrated circuits (ASICs), field-programmable gate arrays (FPGAs), and/or other processing structures. Software and/or firmware implementations can include executable instructions stored on one or more memory devices.

System configurations can include single device architectures or distributed architectures in which multiple devices communicate through one or more networks. A network can include any interconnection of nodes using wired and/or wireless connections, such as local area networks, wide area networks, cellular networks, cloud-based environments, and/or combinations thereof. Distributed implementations can support processing and data storage at remote locations, with network interfaces managing communication among devices and/or components of a system. Components of the disclosure can be virtualized and/or implemented as part of cloud services, microservices, containers, and/or hosted software.

Instructions can be stored by one or more tangible storage media, which can include memory circuits, hard drives, optical storage, flash memory, and/or any suitable non-transitory computer-readable medium. Instructions can be stored by one or more non-transitory memory circuits, such as random access memory, read-only memory, optical storage, magnetic storage, solid-state drives, and/or other memory devices. Data and instructions can be transferred between system components using communication buses, direct memory access, and/or communication protocols.

The present disclosure describes examples selected for clarity of function and statutory support. These examples are not intended to limit the claimed subject matter. Subject matter described herein can be implemented in other forms, which can include alternative steps, step sequences, components, system architectures, and/or technologies available now or in the future. Unless expressly specified, the recitation of the terms “block” or “step” to describe portions of a method or process does not indicate a required order and/or a required limitation, except where an explicit order is described.

Feature combinations disclosed herein are not intended to limit the scope of the disclosure. Features described in separate claims or examples can be combined in any arrangement, regardless of whether at least one (e.g., each) combination is explicitly recited. At least one (e.g., each) dependent claim can be combined with any other claim in the claim set. As used herein, “at least one of” a list of items indicates any subset, permutation, and/or combination of those items, including individual items and repetitions. For example, “at least one of: a, b, or c” covers a, b, c, a and b, a and c, b and c, or a, b, and c.

The phrase “a processor” or “one or more processors,” or similar terms for devices or components, is intended to encompass any implementation in which one or more processors are configured to perform specified operations. This includes a single processor performing all operations, multiple processors performing subsets of operations, or any distribution of operations across multiple processors. Unless explicitly required (for example, by “first processor” and “second processor”), no claim should be interpreted to require any particular processor-to-operation mapping.

No element, act, or instruction should be construed as critical or essential unless explicitly specified as such. As used herein, singular forms (e.g., “a,” “an,” or “the”) are intended to include plural referents unless the context clearly indicates otherwise. The terms “comprise,” “include,” or “have,” and variations thereof, are intended to cover non-exclusive inclusions. The phrase “based on” means “based at least in part on” unless specified otherwise. The term “and” and “or” when used in a list, is inclusive and may be used interchangeably with “and/or” except where exclusive language is explicitly used.

Throughout the disclosure, features described with respect to one aspect or example can be combined with features of other aspects and/or examples unless explicitly stated otherwise. Implementations described herein can be combined in any suitable manner under the scope of the present disclosure.

What is claimed is:

1. A method, comprising:
allocating, using an allocation scheme corresponding to a first phase, a plurality of data groups to a plurality of nodes; and
updating, using a correction scheme corresponding to a second phase, at least one allocation of at least one data group of the plurality of data groups based at least on a convergence parameter and a resource metric, the resource metric corresponding to at least one resource indicator of a hardware configuration detected from at least one node of the plurality of nodes based at least on performance of at least one node command;
wherein the method is performed using one or more processors.

2. The method of claim 1, wherein to update the at least one allocation of the at least one data group comprises:
determining a resource indicator for each of the plurality of nodes based at least on the hardware configuration corresponding to at least one of a memory usage, a processor usage, a network usage, an application value, a thread value, or an API call value for each node of the plurality of nodes.

3. The method of claim 1, wherein to update the at least one allocation of the at least one data group comprises:
identifying the at least one node of the plurality of nodes based at least on the resource metric of the at least one node indicating a relative level of capacity compared to at least one other node of the plurality of nodes.

4. The method of claim 3, wherein the relative level of capacity comprises a measure of utilization, availability, or load corresponding to the at least one resource indicator.

5. The method of claim 1, wherein the at least one data group is reallocated from an overloaded node of the plurality of nodes to a compatible node of the plurality of nodes, the compatible node identified based at least on a second resource metric of the compatible node, the second resource metric indicating a higher available resource capacity for the at least one data group compared to the plurality of nodes.

6. The method of claim 1, wherein to update the at least one allocation of the at least one data group of the plurality of data groups comprises:
updating, using the correction scheme corresponding to the second phase for a plurality of iterations, a plurality of allocations of the plurality of data groups among the plurality of nodes until the convergence parameter is satisfied.

7. The method of claim 6, wherein the convergence parameter corresponds to at least one of (i) an iteration limit corresponding to reallocation, (ii) an iteration parameter corresponding to a decrease in a sum of a plurality of resource metrics exceeding a resource parameter, (iii) at least one termination condition.

8. The method of claim 1, further comprising:
determining the resource metric of the at least one node based at least on applying a first scoring function to a plurality of first resource indicators of the at least one node; and
determining a second resource metric of at least one second node based at least on applying a second scoring function to a plurality of second resource indicators of the at least one second node;
wherein the first scoring function comprises a first weight prioritization of the plurality of first resource indicators based at least one first hardware configuration of the at least one node, and wherein the second scoring function comprises a second weight prioritization of the plurality of second resource indicators based at least one second hardware configuration of the at least one second node.

9. The method of claim 8, further comprising:
detect, by accessing an operating system (OS) or hardware interface of the at least one node and performing the at least one node command, the at least one first hardware configuration based at least on telemetry data of the at least one node returned from the performance of the at least one node command.

10. The method of claim 1, wherein each of the plurality of nodes operate independently from other nodes of the plurality of nodes, and wherein a plurality of first data groups allocated to a first node of the plurality of nodes is disjoint from a plurality of second data groups allocated to a second node of the plurality of nodes.

11. The method of claim 1, wherein to allocate the plurality of data groups to the plurality of nodes comprises:
assigning a plurality of data objects into the plurality of data groups, wherein the plurality of data groups satisfies a size parameter.

12. The method of claim 11, wherein to allocate the plurality of data groups to the plurality of nodes comprises:
aggregating a plurality of weights of the plurality of data objects of at least one of the plurality of data groups to generate a plurality of aggregated weights, each aggregated weight corresponding to a corresponding data group of the plurality of data groups; and
generating an ordered structure comprising a plurality of virtual nodes, at least one virtual node corresponding to at least one of the plurality of nodes, the ordered structure used to allocate the plurality of data groups to the plurality of nodes based at least on the plurality of aggregated weights.

13. The method of claim 1, wherein the correction scheme corresponds to a plurality of reallocation operations to reallocate at least one of the plurality of data groups among the plurality of nodes based at least on a plurality of resource metrics.

14. The method of claim 1, wherein the allocation scheme corresponds to a plurality of allocation operations to (i) generate the plurality of data groups using a plurality of data objects and (ii) allocate the plurality of data groups based at least on at least one mapping function.

15. A system, comprising:
at least one processor to execute operations comprising:
apply an allocation scheme to a plurality of data groups to cause an allocation of the plurality of data groups to a plurality of nodes; and
apply a correction scheme to the plurality of nodes to cause an update in at least one allocation of at least one data group of the plurality of data groups based at least on a convergence parameter and a resource metric, the resource metric corresponding to at least one resource indicator of a hardware configuration of at least one node of the plurality of nodes.

16. The system of claim 15, wherein the operations, when executed by the at least one processor, further cause the at least one processor to:
determine a resource indicator for each of the plurality of nodes based at least on the hardware configuration corresponding to at least one of a memory usage, a processor usage, a network usage, an application value, a thread value, or an API call value for each node of the plurality of nodes.

17. The system of claim 15, wherein the operations, when executed by the at least one processor, further cause the at least one processor to:
identify the at least one node of the plurality of nodes based at least on the resource metric of the at least one node indicating a relative level of capacity compared to at least one other node of the plurality of nodes.

18. The system of claim 17, wherein the relative level of capacity comprises a measure of utilization, availability, or load corresponding to the at least one resource indicator.

19. The system of claim 15, wherein the at least one data group is reallocated from an overloaded node of the plurality of nodes to a compatible node of the plurality of nodes, the compatible node identified based at least on a second resource metric of the compatible node, the second resource metric indicating a higher available resource capacity for the at least one data group compared to the plurality of nodes.

20. A non-transitory computer-readable medium storing instructions that, when executed by at least one processor, cause the at least one processor to perform operations comprising:
allocate, using an allocation scheme corresponding to a first phase, a plurality of data groups to a plurality of nodes; and
update, using a correction scheme corresponding to a second phase, at least one allocation of at least one data group of the plurality of data groups based at least on a convergence parameter and a resource metric, the resource metric corresponding to at least one resource indicator of a hardware configuration of at least one node of the plurality of nodes.
